(19) United States
(12) Patent Application Publication
(10) Pub. No.: US 2006/0008117 A1
(43) Pub. Date: Jan. 12, 2006

(54) Information source selection system and method

(76) Inventor: Yasusi Kanada, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/050,202

(22) Filed: Feb. 4, 2005

(30) Foreign Application Priority Data
Jul. 9, 2004 (JP) 2004-202767

(51) Int. Cl. G06K 9/00; H04N 17/00

(52) U.S. Cl. 382/103; 348/179

(57) ABSTRACT

An arbitrary information source is selected from a plurality of information sources. To that end, a client comprises a pointing device 226 for receiving movement information on a movement in a virtual space, a presence provider 222 for sending the movement information received by the pointing device 226, a space modeler 221 for calculating locations of information sources in the virtual space based on locations of a user of the client 201 itself and the information sources, and an audio renderer 216 for controlling sound effects based on the locations of users in the virtual space.

The present invention relates to a technique of selecting an arbitrary information source out of a plurality of information sources.

### BACKGROUND OF THE INVENTION

As a conference system using a virtual space, there is FreeWalk, which is a conference system developed by Kyoto University (See NAKANISHI, Hideyuki, YOSHIDA, Chikara, NISHIMURA, Toshikazu and ISHIDA, Toru, “FreeWalk: Support of Casual Communication Using A Three-dimensional Virtual Space”, IPSJ Journal, Vol. 39, No. 5, pp. 1356-1364, 1998 (hereinafter, referred to as Non-patent Document 1) and Nakanishi, H., Yoshida, C., Nishimura, T., and Ishida, T., “FreeWalk: A 3D Virtual Space for Casual Meetings”, IEEE MultiMedia, April-June 1999, pp. 2028 (hereinafter, referred to as Non-patent Document 2), for example). FreeWalk is a system in which users of the conference system share a virtual space and users in the same virtual space can talk with one another. By three-dimensional graphics, each user can see an image of the virtual space seen from his viewpoint or from a viewpoint that is near to his viewpoint and able to see himself within the range of vision. Three-dimensional graphics is a technique for simulating a three-dimensional space by computer graphics. As API (Application Programming Interface) for achieving the end, may be mentioned OpenGL (http://www.opengl.org/), which is a de facto standard, and Direct 3D of Microsoft Corporation. An image of a conversational partner is shot by a video camera and projected in real time on a virtual screen located in the image seen from the user's viewpoint, for example. Further, each user can move free in this virtual space. Namely, each user can change his location in the virtual space using a pointing device or keys of a keyboard.

Moreover, there is Somewire, which is a conference system developed by Internal Research Corporation (See U.S. Pat. No. 5,889,843 (hereinafter, referred to as Patent Document 1) and U.S. Pat. No. 6,262,711B1 (hereinafter, referred to as Document 2) and Singer, A., Hindus, D., Stifelman, L., and White, S., “Tangible Progress: Less Is More In Somewire Audio Spaces”, ACM CHI '99 (Conference on Human Factors in Computing Systems), pp. 104-112, May 1999 (hereinafter, referred to as Non-patent Document 3), for example). Somewire is a system in which users of the conference system share a virtual space and users in the same virtual space can talk with one another. In Somewire, voice is reproduced by high quality stereo audio. Further, Somewire has an intuitive tangible interface, since it employs GUI (Graphical User Interface) that can control a location of a conversational partner in a virtual space by moving a doll-like figure.

Furthermore, there is a conference system developed by Hewlett-Packard Company. This conference system uses the distributed 3D audio technique (See Low, C. and Babarit, L., “Distributed 3D Audio Rendering”, 7th International World Wide Web Conference (WWW7), 1998, http://www7.scu.edu.au/programme/fullpapers/1912/com1912.htm (hereinafter, referred to as Non-patent Document 4), for example). The distributed 3D audio technique is a technique that applies a three-dimensional audio technique to a networked system (so-called distributed environment). The three-dimensional audio technique is a technique of simulating a three-dimensional acoustic space. As API for achieving this end, may be mentioned Open AL (http://www.opengl.org/), which is a de facto standard, prescribed by Loki Entertainment Software Inc, and others and DirectSound 3D of Microsoft Corporation, EAX 2.0 (http://www.sei.com/algorithms/eax20.pdf) of Creative Technology, Ltd., for example. Using the three-dimensional audio technique, it is possible to simulate a direction and distance of a sound source seen from a listener in sound reproduction using speakers such as headphones or 2- or 4-channel speakers, and to locate the sound source in an acoustic space. Further, by simulating acoustic properties such as reverberation, reflection by an object such as a wall, sound absorption by air depending on distance, sound interception by an obstacle, and the like, it is possible to express an impression of existence of a room and an impression of existence of an object in a space.

### SUMMARY OF THE INVENTION

Recently, various kinds of information have been provided to users through Internet. However, sometimes, it is not easy to operate a pointing device or the like suitably to access an information source. For example, differently from an able-bodied person, sometimes it is difficult for a handicapped person or an old man having trouble with his hand to operate a pointing device.

Further, in the cases of Internet Radio and Internet Television, it is difficult for a user to find a program that he wants to listen or watch. Namely, in the case of radio or television, a user can listen or watch only one station at once. Thus, it takes time to change and see a channel one after another to find a program that a user wants to listen or watch.

The conference systems described in Patent Documents 1 and 2 and Non-patent Documents 1-4 do not consider movement in a virtual space and selection of an information source.

The present invention has been made taking the above-described state into consideration. And, an object of the present invention is to provide a technique of using a virtual space such that a desired information source can be selected easily out of a plurality of information sources.

According to the present invention, to solve the above problem, a movement instruction is received from a user, and then, the user is moved to a prescribed location in a virtual space having a plurality of information source.

For example, the present invention provides an information source selection system that selects an arbitrary information source out of a plurality of information sources, using a virtual space, wherein: the virtual space includes the above-mentioned plurality of information sources; and the information source selection system comprises a server apparatus for managing locations of the above-mentioned plurality of information sources in the virtual space and a client terminal. The client terminal comprises: a movement receiving means that receives a movement instruction on a movement of a user of the client terminal in the virtual space; a moving means that moves the user in the virtual space, according to the movement instruction received by the movement receiving means; a client sending means that sends positional information on a location of the user moved by the moving means in the virtual space to the server apparatus; a client receiving means that receives positional information on a location of each of the above-mentioned plurality of information sources in the virtual space from the server apparatus; a space modeling means that calculates the location of the user and the locations of the above-mentioned plurality of information sources in the virtual space, based on said positional information on the location of the user in the virtual space and the positional information on the location of each of the above-mentioned plurality of information sources in the virtual space; and a sound control means that controls sound effects applied to a voice of each of the above-mentioned plurality of information sources, based on the locations calculated by the space modeling means.

The server apparatus comprises: a server receiving means that receives the positional information on the location of the user in the virtual space from the client terminal; a storing means that stores the positional information (which is received by the server receiving means) on the location of the user in the virtual space and the positional information on the locations of the above-mentioned plurality of information sources in the virtual space; and a server sending means that sends positional information (which is stored in the storing means) on the locations of the above-mentioned plurality of information sources to the client terminal.

According to the present invention, it is possible to move a user in a virtual space. As a result, it is possible to approach and select an arbitrary information source out of a plurality of information sources existing in the virtual space.

### BRIEF DESCRIPTION OF THE DRAWINGS

FIG. 1 is a diagram showing a network configuration according to an embodiment of the present invention;

FIG. 2 is a diagram showing a hardware configuration of each apparatus in the embodiment;

FIG. 3 is a diagram showing a configuration of a client in the embodiment;

FIG. 4 is a diagram showing a direction and distance of a sound source schematically in the embodiment;

FIG. 5 is a diagram showing processing in an audio renderer schematically in the embodiment;

FIG. 6 shows a first example of a display screen in the embodiment;

FIG. 7 shows a second example of a display screen in the embodiment;

FIGS. 8(A) and 8(B) show examples of various types of clients in the embodiment;

FIG. 9 is a diagram showing a long distance forward movement in the embodiment;

FIG. 10 is a diagram showing a long-distance leftward or rightward movement in the embodiment;

FIG. 11 is a flowchart showing processing of connection of a client to a network in the embodiment;

FIG. 12 is a flowchart showing entrance processing of a client in the embodiment;

FIG. 13 is a flowchart showing processing of movement of its own user of a client in the embodiment;

FIG. 14 is a flowchart showing processing of movement of a user of another client in the embodiment;

FIG. 15 is a diagram showing a functional configuration of a presence server in the embodiment;

FIG. 16 is a flowchart showing a processing procedure of the presence server in the embodiment;

FIG. 17 is a diagram showing a functional configuration of a streaming server in the embodiment;

FIG. 18 is a diagram showing a network configuration according to an embodiment having a sound server;

FIG. 19 is a diagram showing a functional configuration of the sound server in the embodiment having the sound server; and

FIG. 20 is a diagram showing a functional configuration of a streaming server in the embodiment having the sound server.

### DETAILED DESCRIPTION OF THE EMBODIMENT

Now, embodiments of the present invention will be described.

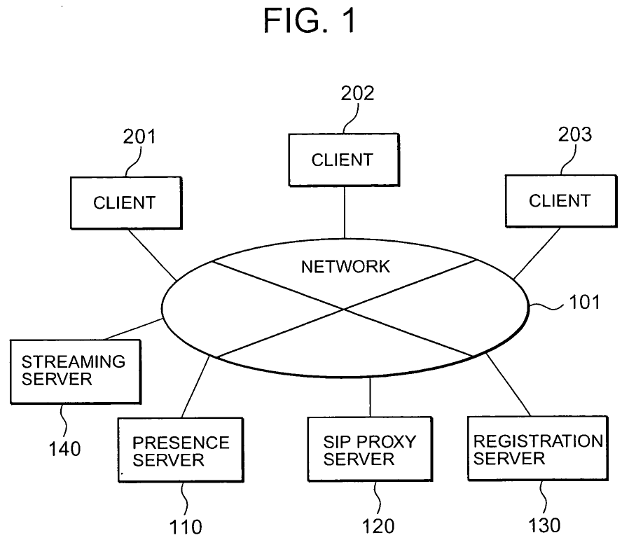

FIG. 1 is a block diagram showing a system configuration of a communication system to which one embodiment of the present invention is applied. As shown in the figure, this system comprises a plurality of clients 201, 202 and 203, a presence server 110 that manages presence, an SIP proxy server 120 that controls sessions, a registration server 130 that registers and authenticates users, and a streaming server 140 that distributes multimedia data such as an image and voice, wherein these apparatuses are connected with one another through a network 101 such as Internet. Here, the presence means a virtual space itself (which includes a plurality of information sources) and positional information of each user in the virtual space.

Although the present embodiment includes three clients, the number of clients is not limited to three and may be two, four or more. Further, in the present embodiment, the network 101 consists of a single domain. However, it is possible that the network consists of a plurality of domains, and the domains are connected with one another to enable communication extending over those domains. In that case, there exist a plurality of presence servers 110, a plurality of SIP proxy servers 120, a plurality of registration servers 130, and a plurality of streaming servers 140.

Next, will be described hardware configurations of the communication system.

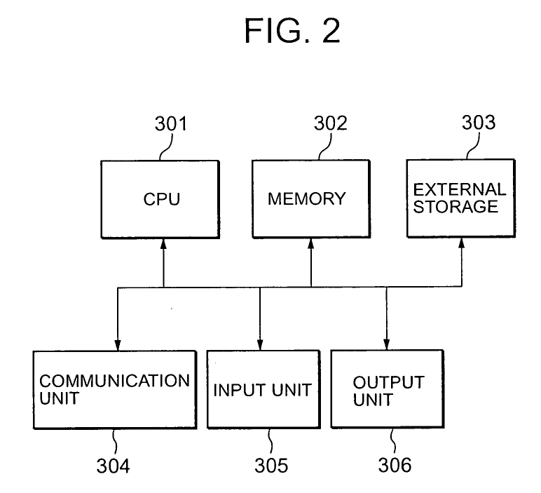

FIG. 2 shows a hardware configuration of each apparatus of the clients 201, 202 and 203, the presence server 110, the SIP proxy server 120, the registration server 130 and the streaming server 140.

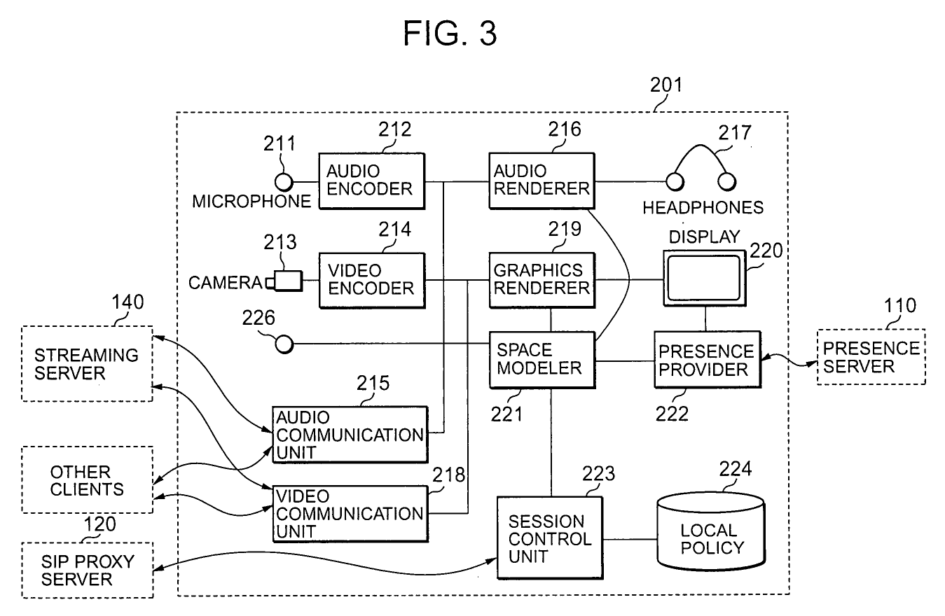

As each client 201, 202 or 203, can be used an ordinary computer system comprising: a CPU 301 for executing data processing and calculation according to programs; a memory 302 from which the CPU 301 can read and write directly; an external storage 303 such as a hard disk; a communication unit 304 for data communication with an external system; an input unit 305; and an output unit 306. For example, a computer system such as a PDA (Personal Digital Assistant) or a PC (Personal Computer) may be used. The input unit 305 and the output unit 306 will be described later in detail referring to FIG. 3.

As each of the presence server 110, the SIP proxy server 120, the registration server 130 and the streaming server 140, can be used an ordinary computer system comprising at least: a CPU 301 for executing data processing and calculation according to programs; a memory 302 from which the CPU 301 can read and write directly; an external storage 303 such as a hard disk; and a communication unit 304 for data communication with an external system. For example, a server or a host computer may be mentioned.

The below-mentioned functions of the above-mentioned apparatuses will be each realized when the CPU 301 executes a certain program (in the case of the client 201, 202 or 203, a program for client; in the case of the presence server 110, a program for the presence server; in the case of the SIP proxy server 120, a program for the proxy server; in the case of the registration server, a program for the registration server; and in the case of the streaming server, a program for the streaming server) loaded onto or stored in the memory 302.

Next, referring to FIG. 3, will be described the input unit 305 and the output unit 306 of the client 201, and a functional configuration of the client 201. It is assumed that the clients 202 and 203 also have similar configurations to the client 201.

As the input unit 305, the client 201 has a microphone 211, a camera 213 and a pointing device 226. The pointing device 226 is an input unit 305 for a user to input movement information of himself in a virtual space. For example, various buttons or a keyboard may be mentioned. As the output unit 306, the client 201 has a headphones 217 adapted for the three-dimensional audio technique, and a display 220.

As functional components, the client 201 comprises: an audio encoder 212, an audio renderer 216, a video encoder 214, a graphics renderer 219, a space modeler 221, a presence provider 222, an audio communication unit 215, a video communication unit 218, a session control unit 223, and a local policy 224.

The audio encoder 212 converts voice into a digital signal. The audio renderer 216 performs processing (such as reverberation and filtering) resulting from properties of a virtual space, using the three-dimensional audio technique. The video encoder 214 converts an image into a digital signal. The graphics renderer 219 performs processing resulting from the properties of the virtual space. The space modeler 221 calculates presence such as user's location and direction in the virtual space, based on inputted movement information. The presence provider 222 sends and receives user's positional information and directional information in the virtual space to and from the presence server 110. The audio communication unit 215 sends and receives an audio signal (a voice signal) in real time to and from another client and the streaming server 140. The video communication unit 218 sends and receives a video signal (an image signal) in real time to and from another client and the streaming server 140. The session control unit 223 controls a communication session between the client 201 and another client or the presence server 110, through the SIP proxy server 120. The local policy 224 will be described later.

Here, a virtual space means a virtually-created space for two-way communication (conference or conversation) with a plurality of information sources, or for watching or listening images or music provided by information sources. An information source may be another user sharing the virtual space, Internet Radio, Internet Television, a player for reproducing music or a video, or the like. The presence server 110 manages the properties of the virtual space and information on users existing in the virtual space. When a user enters a certain virtual space, the presence server 110 sends the properties of the virtual space and information on the other users existing in the virtual space to the client of the user in question. Then, the space modeler 221 of the client in question stores the sent information and his own positional information in the virtual space into the memory 302 or the external storage 303.

The properties of a virtual space are, for example, the size of the space, the height of the ceiling, the reflectance ratios/colors/textures of the walls and the ceiling, the reverberation properties, and the sound absorption rate owing to air in the space. Among them, the reflectance ratios of the walls and the ceiling, the reverberation properties and the sound absorption rate owing to air in the space are auditory properties. The colors and textures of the walls and the ceiling are visual properties. And, the size of the space and the height of the ceiling are both auditory and visual properties.

Further, the properties of the virtual space include information on information sources (Internet Radio, Internet Television, the player, and the like) except the users. For each information source installed in the virtual space, the information on the information source includes information source identification information for identifying the information source in question, the installation location in the virtual space, the best area for a user to watch or listen the information source in question, and the like. For example, in the case of Internet Radio among the information sources in the present embodiment, each channel is taken as one information source, and thus it is assumed that each of audio signals distributed from the streaming server 140 is added with information source identification information. Further, in the case of Internet Television also, each channel is taken as one information source, and thus it is assumed that each of video signals distributed from the streaming server 140 is added with information source identification information. Thus, information source identification information is information that can identify (specify) a type and a channel of the information source concerned.

Next, operation of each function will be described in the order of presence, voice and image.

As for presence, the pointing device 226 receives input of positional information or directional information from its own user, converts the received information into a digital signal, and inputs the digital signal to the space modeler 221. The space modeler 221 receives the input from the pointing device 226 and changes the position and direction of its own user in the virtual space. A method of movement of the user using the pointing device 226 will be described later.

Then, the space modeler 221 sends the positional information (directional information) of its user in the virtual space to the presence server 110 through the presence provider 222. Further, the space modeler 221 receives positional information (directional information) of the other users in the virtual space from the presence server 110 through the presence provider 222. The space modeler 221 holds the positional information (directional information) of the user using the client 201 itself in the virtual space and the positional information (directional information) of the other users in the virtual space. Namely, the space modeler 221 receives the positional information and the directional information of the other users in the virtual space through the network 101, and accordingly it is inevitable that delays and jitters occur with respect to the locations and directions of the other users in the virtual space. On the other hand, a delay scarcely occurs in the location and direction of the user of the client 201 itself, since the pointing device directly inputs them to the space modeler 221. Thus, on the display 220, the user of the client 201 can confirm his location in real time after his movement, and can easily operate the pointing device 226.

As for voice, the microphone 221 collects voice of the user using the client 201 and sends the collected voice to the audio encoder 212. The audio encoder 212 converts the received voice into a digital signal and outputs the digital signal to the audio renderer 216. Further, the audio communication unit 215 sends and receives an audio signal or signals in real time to and from one or more other clients, and outputs the received audio signal or signals to the audio renderer 216. Further, the audio communication unit 215 receives an audio signal in real time from the streaming server 140 and outputs the received audio signal to the audio renderer 216.

Into the audio renderer 216, are inputted digital output signals outputted from the audio encoder 212 and the audio communication unit 215. Then, using the three-dimensional audio technique, the audio renderer 216 calculates how voice of the other users (communication partners) and voices (music) of non-user information sources (i.e., information sources other than the users) are heard in the virtual space, based on the auditory properties of the virtual space, the locations of the user of the client 201 itself and the other users located in (mapped into) the virtual space, and the locations of the non-user information sources (Internet Radio and the like). The properties of the virtual space include the information source identification information of each information source installed in the virtual space and the installation location of that information source. Thus, the audio renderer 216 locates an audio signal received from the streaming server 140 at the installation location (in the virtual space) corresponding to the information source identification information of that audio signal, to perform rendering of that audio signal.

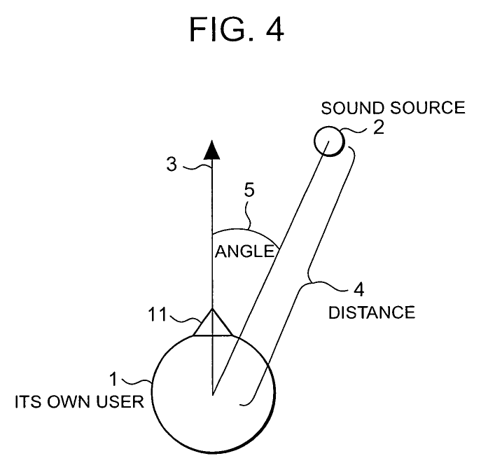

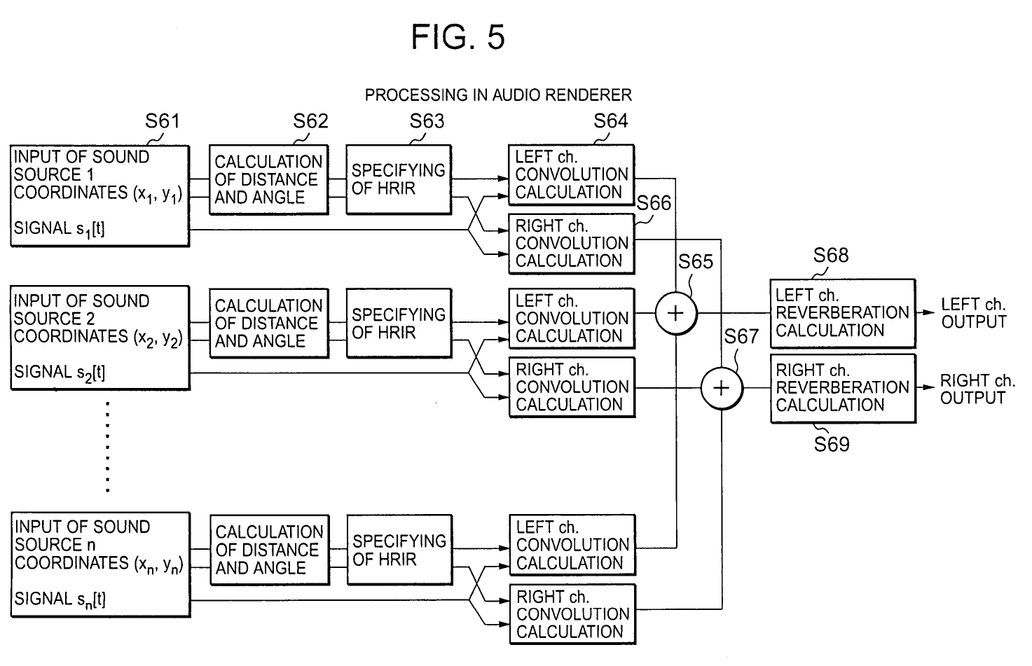

Now, referring to FIGS. 4 and 5, the audio renderer 216 will be described in detail.

FIG. 4 is a diagram schematically showing a direction and distance of an information source (sound source) such as another user, Internet Radio, or the like. FIG. 4 illustrates a head 1 showing a person seen from just above and a sound source 2 as an information source. The head 1 has a nose 11 for indicating a direction of the face. In other words, the head 1 faces in the direction 3 of the added nose 11. In the three-dimensional audio technique, a direction and distance of sound are expressed by HRIR (Head Related Impulse Response), which shows mainly how sound changes around the head 1 (impulse response), and pseudo reverberation generated by a virtual environment such as a room. And, HRIR is determined by a distance 4 between the sound source 2 and the head 1 and angles (horizontal and vertical angles) 5 between the head 1 and the sound source 2. Here, it is assumed that the memory 302 or the external storage 303 previously stores values of HRIR measured for each distance and for each angle, using a dummy head (head 1). Further, as the values of HRIR, different values are used for a left channel (values measured at a left ear of the dummy head) and for a right channel (values measured at a right ear of the dummy head), to express senses of direction of right and left, front and back, and up and down.

FIG. 5 is a diagram showing processing in the audio renderer 216. The audio renderer 216 performs the following calculation for each packet received (usually at intervals of 20 ms) using the below-described RTP (Real-time Transport Protocol) or RTSP (Real Time Streaming Protocol) for each sound source. As shown in the figure, for each sound source, the audio renderer 216 receives input of a signal string sᵢ[t] (t=1, . . . ) and coordinates (xᵢ, yᵢ) of that sound source in the virtual space (S61). Here, coordinates of each sound source in the virtual space are inputted from the space modeler 221. After the space modeler 221 maps (locates) each sound source onto the virtual space, the space modeler 221 inputs the coordinates (positional information in the virtual space) of each sound source to the audio renderer 216. Further, a signal string of each sound source is inputted from the audio communication unit 215.

Then, for each sound source, the audio renderer 216 uses the inputted coordinates to calculate the distance and angle (azimuth) between the user of the client 201 itself and the sound source in question (S62). Then the audio renderer 216 specifies HRIR corresponding to the distance and azimuth from the user of the client 201 itself, out of HRIR values stored previously in the memory or the external storage 303 (S63). Here, the audio renderer 216 may use HRIR values calculated by interpolation of the HRIR values stored in the memory 302 or the like.

Then the audio renderer 216 performs convolution calculation using the signal string inputted in S61 and the left channel HRIR of the HRIR specified in S63, to generate a left channel signal (S64). Then the audio renderer 216 adds the respective left channel signals acquired from all the sound sources (S65). Further, the audio renderer 216 performs convolution calculation using the signal string inputted in S61 and the right channel HRIR of the HRIR specified in S63, to generate a right channel signal (S66). Then the audio renderer 216 adds the respective right channel signals acquired from all the sound sources (S67).

Next, the audio renderer 216 adds reverberation to the left channel signal acquired from the above-mentioned addition (S68). Namely, the audio renderer 216 calculates the reverberation based on how sound changes (impulse response) according to the properties of the virtual space. As a method of calculation of reverberation, may be mentioned a calculation method called FIR (Finite Impulse Response) or IIR (Infinite Impulse Response). These methods are fundamental ones relating to a digital filter, and description of them is omitted here. Further, similarly to the left channel, the audio renderer 216 adds reverberation to the right channel signal acquired from the above-mentioned addition (S69). Although the specification of HRIR (S63) is performed for each packet as described above, the reverberation calculations (S68 and S69) and the convolution calculations (S64 and S66) each generate a part to be carried forward to the next packet. Accordingly, it is necessary to hold the specified HRIR or the inputted signal string until processing of the next packet.

Thus the audio renderer 216 controls sound effects to obtain sound to be heard at the location of the user of the client 201 itself in the virtual space, by performing processing such as volume control, superposition of reverberation and reflection, filtering, and the like on voices of the users as communication partners and voices of the non-user information sources. In other words, the audio renderer 216 orients and reproduces voices by performing the processing resulting from the properties of the virtual space, the locations of the other users, and the locations of the non-user information sources.

As for image, the camera 213 shoots the head of the user, and shot images are successively sent to the video encoder 214. Then the video encoder 214 converts the images into a digital signal and outputs the signal to the graphics renderer 219. Further, the video communication unit 218 sends and receives a video signal or video signals in real time to and from one or more other clients, and outputs the audio signal or signals to the graphics renderer 219. Further, the video communication unit 218 receives a video signal (moving picture data) from the streaming server 140, and outputs the received video signal to the graphics renderer 219. The graphics renderer 219 receives digital output signals from the video encoder 214 and the video communication unit 218.

Then the graphics renderer 219 calculates how the information sources such as the other users, Internet Radio, and the like are seen in the virtual space, based on the visual properties of the virtual space and the location and direction of the user of the client 201 itself in the virtual space (coordinate transformation). These properties and information are held by the space modeler 221. Here, the properties of the virtual space includes the information source identification information and the installation location of each information source located in the virtual space. Accordingly, the graphics renderer 219 inserts the video signal received from the streaming server 140 into an installation location corresponding to the information source identification information of that video signal in the virtual space.

Next, with respect to the communication partners' images outputted from the video communication unit 218 and the video signal sent from the streaming server 140, the graphics renderer 219 performs the processing resulting from the properties of the virtual space, from the viewpoint of the location of the user of the client 201 itself, based on the above-mentioned calculation, to generate image data to be outputted onto a display screen. This image generated by the graphics renderer 219 is outputted onto the display 220, and reproduced as an image seen from the viewpoint of the user of the client 201. The user refers to the output of the display 220.

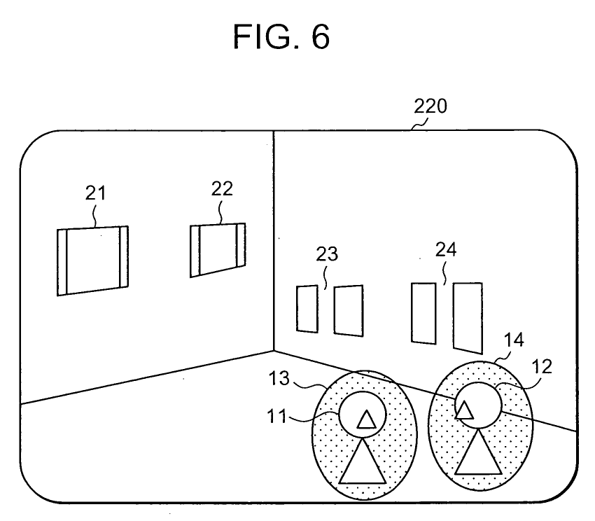

FIG. 6 shows an example of the virtual space shown on the display 220. In the example shown, rendering is performed using the three-dimensional graphics technique. Based on the properties of the virtual space, such as the size of the virtual space, walls, and the like, and three-dimensional data of each information source (a user, Internet Radio, or the like) in the virtual space, the graphics renderer 219 generates a two-dimensional image and displays the generated image on the display 220. These properties and data are stored in the memory 302 or the external storage 303.

In the example shown in the figure, is shown a two-dimensional image obtained by seeing walls, a ceiling and a floor arranged in the virtual space, two abutters 11 and 12 expressing the other users, and four non-user information sources 21-24, from the viewpoint determined from the location and direction of the user of the client 201 in the virtual space. When it is wished to change the viewpoint in the virtual space, the pointing device 226 is used to change the location and direction of the user himself. As a result, his viewpoint is changed and the view from the changed viewpoint is displayed in real time on the screen. In the example shown, the user using the client 201 itself is not displayed.

The abutter 11 expresses a first user (other than the user of the client 201) using the client 202, and the abutter 12 a second user (other than the user of the client 201) using the client 203. Although not shown, a first user's image shot by the camera 213 of the client 202 is pasted on the abutter 11 by texture mapping, and a second user's image shot by the camera 213 of the client 203 is pasted on the abutter 12 by texture mapping. When a user as a communication partner turns, also the texture map is turned. Accordingly it is possible to grasp directions in which the first and second user face in the virtual space. In the example shown, the abutters 11 and 12 are expressed only by figures (or images). However, it is possible to display user information (for example, character information such as an address) of a user corresponding to each abutter 11, 12, in the neighborhood of the figure.

Further, around each abutter 11, 12, is displayed a certain area, i.e., an aura (territory) 13 or 14. In the real space, one talks with another person, keeping some distance from that person. In other words, sometimes one feels unpleasant when another person is too close to him. Thus, an aura is an area for ensuring a certain distance from another person. When the user moves, he can not move into an aura 13 or 14 of another user.

It is possible that each user has an aura 13, 14 of a size fixed to that user. Namely, the size of the aura (area) of each user is set in the local policy 224 of the client of that user. When the space modeler 221 performs the below-described entrance processing for entering into a virtual space, the space modeler 221 receives the auras of the other users existing in the virtual space and stores the received auras into the memory 302 or the external storage. The graphics renderer 219 reads the sizes of the auras of the other users, which are stored in the memory or the like, and then displays those auras on the display 220.

Further, in the example shown, a shape of each aura is displayed as a sphere (a round shape). However, a polyhedron may be used instead of a sphere. Or, the shape of an aura may be an ellipse. In the case where an aura has an elliptical shape, it may be assumed that one focus expresses the location of the user concerned. In that case it may be assumed that the user faces toward the other focus. Namely, an aura is an ellipse that is long in front of the user and short in the rear of the user. This expresses that user's attention much tends to be directed forward. It is assumed that slenderness of an ellipse can be changed according to user's preference or the like. Further, it is assumed that display of auras can be made to disappear on the display 220.

The properties of a virtual space includes information on the information sources 21-24 such as Internet Radio, Internet Television and the like installed in the virtual space. Further, the properties of a virtual space is stored in the memory 302 or the external storage. In the example shown, displays 21 and 22 for displaying information sources such as Internet Television are displayed. On both left and right sides of each display 21, 22, speakers are provided to output voice corresponding to a video signal outputted from that display. The graphics renderer 219 reads information on the information sources 21 and 22, which is stored in the memory or the like, and displays respective video signals (images) received from the streaming server 140, by texture mapping at prescribed places in the virtual space. As seen from the information sources 21 and 22 shown in FIG. 6, the display spaces are determined to have prescribed sizes, and thus, calculation of the texture mapping is performed such that the displayed images fit into respective display spaces.

Further, in the case of the example shown, speakers 23 and 24 for outputting voice/music of the information sources such as Internet Radio are displayed. In the example shown, a set of two speakers for left and right channels are provided for each information source. In the case of reproducing 5.1-channel sound, a set of six speakers are provided for each information source. The audio renderer 216 reads information on the information sources 23 and 24, which is stored in the memory or the like, and reproduces audio signals received from the streaming server 140 at prescribed places in the virtual space and outputs the reproduced audio signals to the headphones.

The audio renderer 216 buffers audio signals received from the other users for about 40-200 ms before reproducing, while buffers the audio signals received from the streaming server 140 for several seconds before reproducing. This is because two-way conversation is required with another user and it is necessary to decrease a delay as far as possible even if a packet does not arrive before reproduction and the sound quality deteriorates. On the other hand, streaming is one-way communication, and usually a delay of several seconds does not matter, while it is necessary to await a delayed packet to avoid deterioration of the sound quality as far as possible.

The above-mentioned information source identification information is used to associate an image (moving picture) of a video signal or voice (music) of an audio signal received from the streaming server 140 with an installation location of an information source. Further, as described above, each channel is taken as an information source. As a result, for selection of an image (moving picture) or a voice (music) to watch or listen, the user can watch and listen a plurality of information sources 21-24 all at once. And, the user can easily select an image or voice/music that he wishes to watch or listen out of these information sources 21-24. When the user of the client 201 itself determines an information source that he wishes to watch, the user moves toward the information source determined in the virtual space. As a result, the user's viewpoint changes, and the virtual space centering at the determined information source is displayed on the display 220. When the user moves toward the determined information source, the audio renderer 216 controls the voce of that information source to be heard louder.

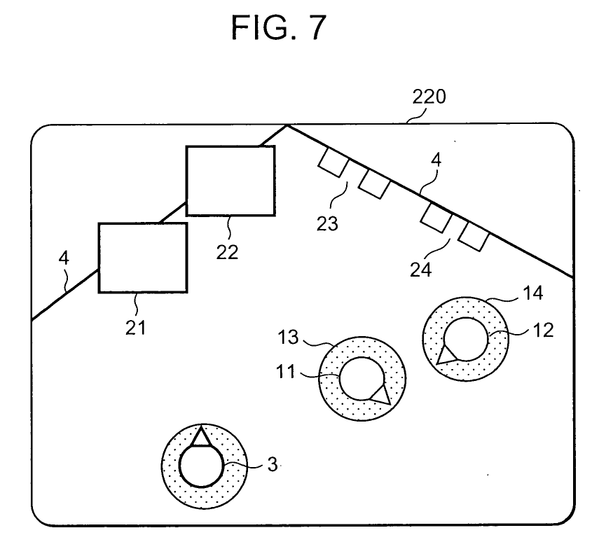

FIG. 7 is a plan view display showing the virtual space of FIG. 6. In the example shown, based on the properties of the virtual space, the location of the user of the client 201 itself in the virtual space and information on the other users, the space modeler 221 displays a two-dimensional image that is obtained by seeing, from just above, the information sources 11, 12, 21-24 located in the virtual space. The mentioned properties, location and information are stored in the memory 302 or the external storage 303. In the case where the information sources 21 and 22 are Internet Television, images seen from the front are displayed even if FIG. 7 is a plan view. Namely, images (pictures) are scaled down simply, and then displayed at the respective installation location for those images.

The graphics renderer 219 displays the virtual space such that the location and direction of the user of the client 201 itself are fixed and the virtual space and the other users in the virtual space move and turn relatively to the user of the client 201 taken as the center. When the user of the client 201 moves or turns using the pointing device 226, then a screen in which the virtual space and the information sources in the virtual space are moved or turned relatively is displayed in real time. In the example shown, the user of the client 201 itself is always fixed to face forward (toward the upper part of the screen). Accordingly, when the user of the client 201 turns, the walls 4 in the virtual space moves. Thus it is possible to express relative positional relations between the user of the client 201 and the information sources.

For real time voice or moving picture communication with another client (another user), RTP (Real-time Transport Protocol), i.e., the protocol described in the document RFC 3550 issued by IETF (Internet Engineering Task Force). Further, the protocol SIP (Session Initiation Protocol) described in the document RFC 3261 issued by IETF is used to control a start and end of communication. Also, distribution of a voice or image by the streaming server 140 is performed according to the RTP, and controlled according to, for example, RTSP (Real Time Streaming Protocol) described in the document RFC 2326 issued by IETF. RTSP is a protocol used for real time distribution of a voce or moving picture on a TCP/IP network. Use of RTSP enables streaming in which a voice or moving picture is reproduced at the same time that data of the voice or moving picture are downloaded.

Hereinabove, the client 201 of FIG. 2 has been described. In the client 201, the microphone 211, the camera 213, the headphones 217, the pointing device 226 and the display 220 are realized by hardware. On the other hand, the audio encoder 212 and the video encoder 214 are realized by software, hardware, or their combination. Further, the audio communication unit 215, the video communication unit 218, the space modeler 221 and the session control unit 223 are ordinary realized by software.

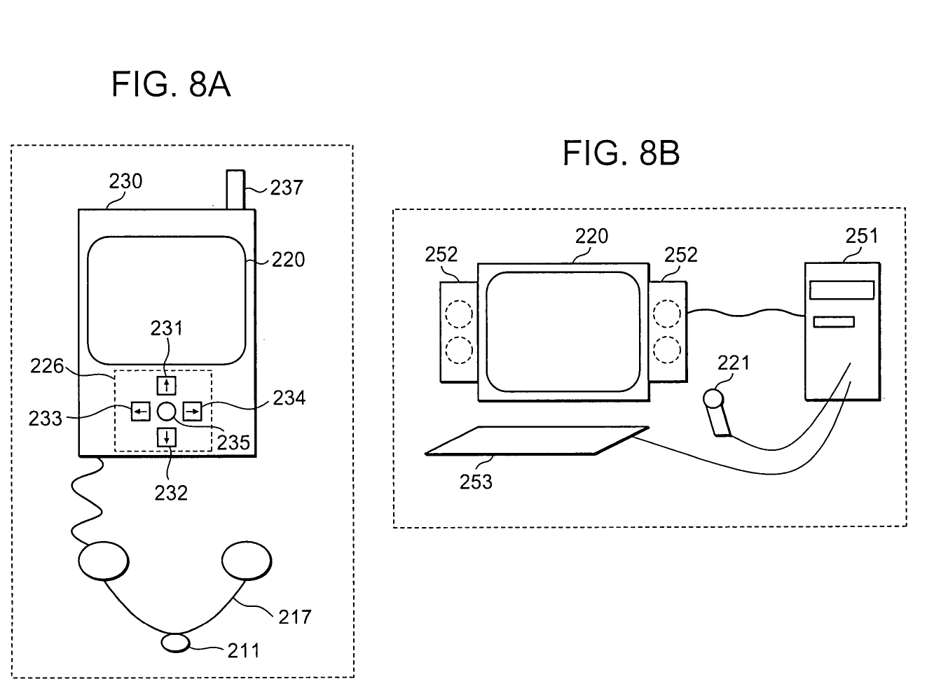

Next, referring to FIG. 8, examples of various types of clients 201, 202 and 203 will be described.

A client shown in FIG. 8(A) has a size and functions near to a PDA or a handheld computer. A client body 230 is provided with a camera 213, a display 220, a pointing device 226, and an antenna 237. Further, a headset connected to the body 230 comprises headphones 217 and a microphone 211.

The pointing device 226 has a forward movement button 231, a backward movement button 232, a leftward movement button 233, a rightward movement button 234 and a selection button 235. For example, when the forward movement button 231 is pushed, the user moves forward in the virtual space, and when the backward movement button 232 is pushed, the user moves backward in the virtual space. Movements in the virtual space will be described in detail later.

Further, the pointing device 226 may be a touch panel. Namely, a surface of the display 220 may be a touch screen covered with a transparent screen (a touch panel) in which elements for detecting a touch of a finger or the like are arranged. The user can easily perform input operation by touching the display 220 with his finger or a special-purpose pen.

Although the headset shown in the figure is wired to the body 230, the headset may be connected wirelessly through Bluethooth or IrDA (infrared). Further, the client is connected to the network 101 by means of the antenna 237 through a wireless LAN.

A client shown in FIG. 8(B) is a desktop computer. A computer body 251 is connected with a microphone 211, a camera 213, a display 220, speakers 252 functioning as substitutes for the headphones, and a keyboard 253 functioning as a substitute for the pointing device 226. Or, the above-mentioned touch panel may be used as the pointing device 226. Further, it is considered to connect this client to a LAN through twisted wire, and further the LAN to the network 101.

Next, will be described a method of moving in a virtual space.

First, will be described a method of moving in the case where the pointing device 226 is the buttons 231-234 shown in FIG. 8(A). For example, to give an instruction of a short distance forward movement, the user pushes the forward movement button 231 for a shorter time than a prescribed time (hereinafter, this operation is referred to as a short push). The short distance forward movement means advancement (movement) from the current location of the user in the virtual space, by a prescribed distance in the direction in which the user faces at present (i.e., forward) in the virtual space. The space modeler 221 receives input of a short push from the forward movement button 231, and moves its own user forward by the prescribed distance.

In the case of giving an instruction of a short distance backward movement, the user pushes the backward movement button 232 for a short time, similarly to a short distance forward movement. The space modeler 221 receives input of a short push from the backward movement button 232, and moves its own user backward by the prescribed distance.

Further, in the case of giving an instruction of a short distance leftward or rightward movement, the user pushes the leftward movement button 233 or the rightward movement button 234 for a short time. Receiving input of a short push of the leftward movement button 233, the space modeler 231 turns its own user through several degrees counterclockwise in the virtual space. Further, receiving input of a short push of the rightward movement button 234, the space modeler 231 turns its own user through several degrees clockwise in the virtual space.

Further, in the case of giving a long distance forward movement, the user pushes the forward movement button 231 for a longer time than the prescribed time (hereinafter, this operation will be referred to as a long push). The long distance forward movement means a movement close up to another user who exists in front of and at the shortest distance from the current location of the user in the virtual space. Namely, the user moves up to a prescribed distance short of another user who exists in front of him. When the space modeler 221 receives a long push of the forward movement button 231, then the space modeler 221 refers to the local policy 224 stored in the external storage 303 of the client 201 itself and the local policy 224 of a user who exists in front of the user of the client 201, to determine a location to which the user of the client 201 moves.

For example, it is assumed that the local policy 224 of a first client stores “aura=50 cm” and the local policy 224 of a second client stores “aura=60 cm”. This means that the user of the first client always keeps a distance of 50 cm or more from the other users, or forbids another user's entry within a 50-cm radius. Similarly, the above means that the user of the second client always keeps a distance of 60 cm or more from the other users. In this state, when the user of the first client performs the long distance forward movement toward the user of the second client, then the space modeler 221 compares the local policy 224 of the first client and the local policy 224 of the second client. And, the space modeler 221 identifies the larger aura value, “aura=60 cm”. Then the space modeler 221 moves the first user up to a location at which the first user collides with the aura of the second user (i.e., 60 cm short of the second user).

Thus, employing the aura having the larger value, it is possible to ensure a distance (from another user) that is pleasant for all the users. It is assumed that a local policy 224 is previously inputted by the user through the input unit 305 and stored in the external storage 303.

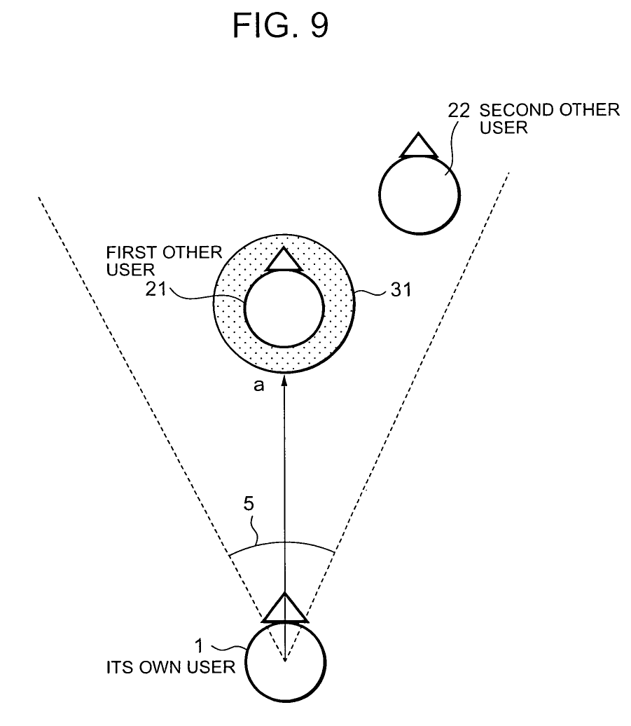

FIG. 9 is a diagram showing a long distance forward movement schematically. FIG. 9 shows a user 1 of the client itself, who is to perform the long distance forward movement in the virtual space, and two other users, i.e., a first user 21 and a second user 22 both located in front of the user 1 in the virtual space. Further, an aura 31 is displayed around the first user 21.

In this state, when the user 1 pushes the forward movement button 231 for a long time to give an instruction of the long distance forward movement, then the space modeler 221 identifies the first user 21 who exists in front of the user 1 and is closest to the user 1. The space modeler 221 compares the aura value of its own user 1 with one of the first user 21, to identify the larger aura value. Then the space modeler 221 moves the user 1 to a location a at a distance of the identified value of the aura from the first user 21. In the example shown, it is assumed that the value of the aura of the first user 21 is larger than or same as the value of the aura of its own user 1.

Further, it is assumed that other users in front of the user 1 include users who exist in front of the user 1 and within his scope of a predetermined angle 5. Namely, if it were not for the first user 21, the space modeler 221 would identify the second user 22 who exists in front of the user 1 and within the scope of the predetermined angle 5, and move the user 1 toward the second user 22. Thus, in the case of another user who exists in front of, but not directly in front of, the user 1, it is possible to move the user 1 close up to the mentioned “another user” (i.e., up to a point at which the user 1 collides with the aura of the mentioned “another user”). Here, it is assumed that the prescribed angle 5 is previously determined based on preference of the user. Further, it may be assumed that the user can change the angle 5 at any time by inputting a desired angle through the input unit 904. Or, it may be assumed that the space modeler 221 adjusts the angle depending on the density of the other users existing in the virtual space. For example, when the density is more than or equal to a certain value, the space modeler 221 selects a prescribed angle, while when the density is smaller than the certain value, the space modeler 221 selects an angle larger than the mentioned prescribed angle.

In the case of giving an instruction of a long distance backward movement, the user pushes the backward movement button 232 for a long time. Then, similarly to the case of the long distance forward movement, the user can move close up to another user existing in the rear of the user (i.e., up to a point at which the user collides with the aura of the mentioned “another user”).

In the case of giving an instruction of a long distance leftward or rightward movement, the user pushes the leftward movement button 233 or the rightward movement button 234 for a long time. The long distance leftward or rightward movement means a movement close up to another user who exists in the direction of the least rotation angle for counterclockwise or clockwise rotation from the direction of the user of the client itself among users existing within a certain range (distance) from the location of the user of the client itself in the virtual space.

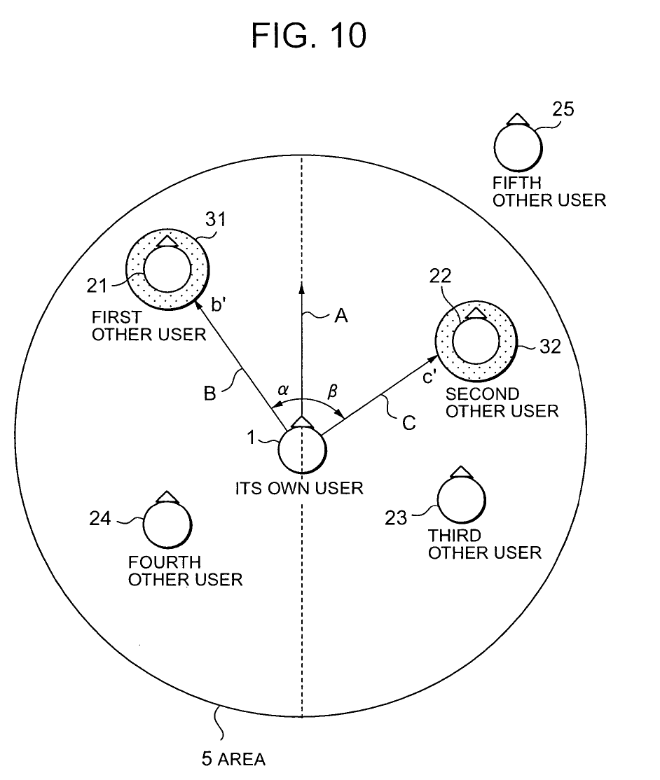

FIG. 10 is a diagram showing a long distance leftward or rightward movement schematically. FIG. 10 shows the user 1 of the client itself and five other users, i.e., a first user 21, a second user 22, a third user 23, a fourth user 24 and a fifth user 25. Further, a circle centering at the user 1 sets an area 5 for identifying other users existing within a certain range (distance) from the user 1. The radius of the area 5 is set according to the size of the virtual space or a scale (not shown) to which the virtual space is displayed on the display. In the example shown, it is assumed that the values of the auras of the first user 21 and the second user 22 are larger than the value of the aura of the user 1.

In this state, when the leftward movement button 233 is pushed for a long time, the space modeler 221 identifies the first user 21 who exists in the closest direction (the direction of the least rotation angle) for counterclockwise rotation from the direction of the user 1, i.e., the forward direction A, among the users (other than the user 1) existing in the prescribed area 5. Then the space modeler 221 turns the user 1 counterclockwise until the first user 21 comes in front of the user 1 (a counterclockwise turn of α degrees). At that time, the user 1 faces in the direction B in which the first user 21 comes in front of him. Then, similarly to the above-described long distance forward movement, the space modeler 221 moves the user 1 toward the first user 21, until the user 1 moves to the point b′ close up to the first user 21 (a point at which the user 1 collides with the aura 31). Although the fourth user 24 exists within the area 5, the fourth user 24 exists in a more distant direction (i.e., a direction of a larger rotation angle) than the first user 21 for counterclockwise rotation from the direction A of the user 1. Accordingly, when the leftward movement button 233 is pushed for a long time, the space modeler 221 does not identify the fourth user 24.

In the case where the rightward movement button 234 is pushed for a long time in the state illustrated in the figure, the space modeler 221 identifies the second user 22 who exists in the closest direction (the direction of the least rotation angle) for clockwise rotation from the direction of the user 1, i.e., the forward direction A, among the users (other than the user 1) existing in the area 5. Then, similarly to the case where the leftward movement button 233 is pushed for a long time, the space modeler 221 turns the user 1 clockwise until the second user 22 comes in front of the user 1 (a clockwise turn of β degrees). Then the space modeler 221 moves the user 1 toward the second user 22, until the user 1 moves to the point c′ close up to the second user 22 (a point at which the user 1 collides with the aura 32). Although the fifth user 25 exists in the closest direction (i.e., a direction of a smaller rotation angle) from the direction A of the user 1, the fifth user 25 does not exist within the area 5 (i.e., away from the user 1 at more than the prescribed distance). Accordingly, when the rightward movement button 234 is pushed for a long time, the space modeler 221 does not identify the fifth user 252.

In the case of a long distance forward, backward, leftward or rightward movement, when the identified destination is a non-user information source such as Internet Radio, then the user is moved to some point within the best area for that information source. The best area for an information source is one of the previously-determined properties of a virtual space, and is a prescribed area where the information source in question can be watched or listened pleasantly in the virtual space.

Next, will be described a method of movement in the case where the pointing device 226 is a touch panel placed on the display 220. In the touch panel, input operation is performed by touching a screen of the output unit, with a finger or a special-purpose pen. The touch panel detects a place touched by a finger to designate the place (coordinates) in the screen, and gives an instruction of movement to the space modeler 221.

For example, to give a short distance forward movement, the user strokes (rubs) a length shorter than a prescribed length (for example, 2 cm) on the touch panel (display 220) in the forward direction (the direction in which the user faces) from the location of the user in the virtual space displayed on the display 220. The touch panel detects the contact, and notifies the space modeler 221 of the coordinates of the line segment detected on the display. Based on the length specified from the line segment coordinates inputted from the touch panel, the space modeler 221 moves the user of its own client forward by a prescribed distance. The case of giving an instruction of a short distance backward movement is similar to the case of giving a short distance forward movement. The user strokes a shorter length than the prescribed length on the touch panel in the backward direction (the reverse direction from the direction in which the user faces) from the location of the user in the virtual space displayed on the display 220.

In the case of giving a short distance leftward or rightward movement, the user strokes a shorter length than the prescribed length in the leftward or rightward direction similarly to the case of a shot distance forward movement. The short distance leftward or rightward movement means advancement (movement) from the current location of the user in the virtual space, by a prescribed distance in the leftward or rightward direction.

Further, in the case of giving a long distance forward movement, the user strokes a longer length than a prescribed length (for example, 2 cm) on the touch panel (display 220) in the forward direction from the location of the user in the virtual space displayed on the display 220. As a result, similarly to the case of a long push of the above-mentioned forward movement button 231, the user is moved close up to another user who exists in front of and at the shortest distance from the current location of the user of the client itself in the virtual space. In the case of giving a long distance backward movement, the user strokes a longer length than a prescribed length (for example, 2 cm) on the touch panel in the backward direction from the location of the user in the virtual space displayed on the display 220. As a result, similarly to the case of a long push of the above-mentioned backward movement button 232, the user is moved close up to another user who exists in the rear of the user of the client itself and at the shortest distance from the current location of the user of the client itself in the virtual space.

Further, in the case of giving a long distance leftward or rightward movement, the user strokes a longer length than a prescribed length (for example, 2 cm) on the touch panel in the leftward or rightward direction from the location of the user in the virtual space displayed on the display 220. As a result, similarly to the case of a long push of the above-mentioned leftward movement button 233 or rightward movement button 234, the user is moved close up to another user who exists in the closest direction (the direction of the least rotation angle) for counterclockwise or clockwise rotation from the current direction of the user of the client itself among users existing within a certain range (distance) from the current location of the user of the client itself in the virtual space.

In the case where a touch panel is used to give an instruction of a user's movement, a finger motion is quantized so that wavering of the finger motion does not affect the movement instruction. Namely, the touch panel detects a movement of user's finger or hand, and notifies the space modeler 221 of coordinates of the detected line segment. With respect to the line segment (the moving distance) inputted from the touch panel, the space modeler 221 compares an absolute value of a left-right direction component x of the line segment and an absolute value of a front-back direction component y. When the absolute value of the left-right direction component x is larger than the absolute value of the front-back direction component y, then the space modeler 221 judges that the line segment means a leftward or rightward movement, and neglects the value of y. When the absolute value of the front-back direction component y is larger than the absolute value of the left-right direction component x, then the space modeler 221 judges that the line segment means a forward or backward movement, and neglects the value of x.

Further, in the case where the line segment is judged to be a leftward or rightward movement and the absolute value of x is smaller than a prescribed value (for example, 2 cm), the space modeler 221 judges that the line segment means a short distance movement. And, when the absolute value of x is larger than the prescribed value (for example, 2 cm), then the space modeler 221 judges that the line segment means a long distance movement. Similarly, in the case where the line segment is judged to be a forward or backward movement and the absolute value of y is smaller than a prescribed value (for example, 2 cm), the space modeler 221 judges that the line segment means a short distance movement. And, when the absolute value of y is larger than the prescribed value (for example, 2 cm), then the space modeler 221 judges that the line segment means a long distance movement. As a result, a handicapped person or old man having trouble with his fingertip can easily move to a suitable location in the virtual space.

Or, it is possible not to employ the quantization in which finger movements (moving quantities) are limited to two types, i.e., a short distance movement and a long distance movement. In this case, similarly to the above-described method, the space modeler 221 classifies line segments (moving distances) inputted from the touch panel into a leftward or rightward movement and a forward or backward movement. Thereafter, the space modeler 221 moves the user by a distance proportional to a forward/backward or leftward/rightward drag quantity (finger stroke) inputted from the touch panel. This case requires accurate dragging (finger stroke), and thus, input is difficult for an old man or handicapped person. However, this case is favorable in that a nonhandicapped person can input more speedily.

The above-described touch panel may be a touch pad. A touch pad is a pointing device that can move a mouse cursor by stroking its flat operation surface with a finger, or perform an operation corresponding to a mouse button click by tapping its operation surface. A touch pad is used as a pointing device for a notebook computer, and arranged, for example, in the neighborhood of a keyboard, not on a display 220.

Further, the pointing device 226 may be a mouse.

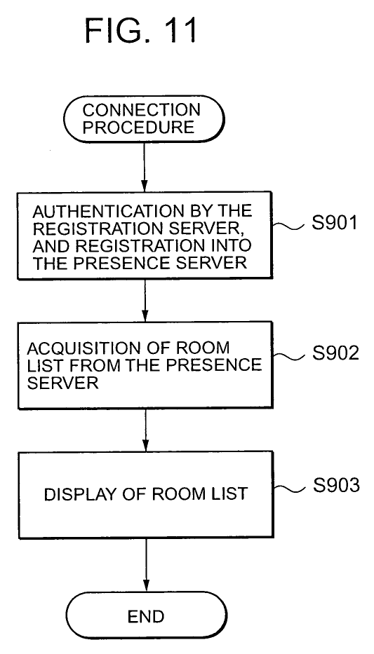

Next, referring to FIGS. 11-15, will be described processing procedures in the client 201.

FIG. 11 shows a processing procedure for connecting the client 201 to the network 101. The connecting procedure shown in the figure is executed at the time of turning on the power for the client 201. First, the session control unit 223 sends a login message including identification information and authentication information of the user to the SIP proxy server 120 (S901). Receiving the login message, the SIP proxy server 120 sends an authentication request message for the user to the registration server 130. Then the registration server 130 authenticates the user's identification information and authentication information, and sends the user's identification information to the presence server 110. For communication between the client and the registration server 130, it is considered to use a REGISTER message of the protocol SIP (Session Initiation Protocol) prescribed in the document RFC 3261 of IETF. The client sends a REGISTER message to the registration server 130 through the SIP proxy server 120, periodically.

Further, for communication between the presence provider 222 of the client 201 and the presence server 110, it is possible to use a SUBSCRIBE message of SIP prescribed in the document RFC 3265 of IETF. A SUBSCRIBE message is an event request message that previously requests reception of a notification at the time of event occurrence. The presence provider 222 requests the presence server 110 to notify an event that has occurred with respect to a room list and an attendance list (managed by the presence server 110) of the virtual space. In the case where the presence provider 222 uses a SUBSCRIBE message, the presence provider 222 communicates with the presence server 110 through the session control unit 223 and the SIP proxy server 120.

Next, the presence provider 222 receives the room list from the presence server 110 (S902). Here, in the case where a SUBSCRIBE message was used in S901, the room list is sent using a NOTIFY message as the event notification message. Then the presence provider 222 displays the received room list on the display 220 (S903).

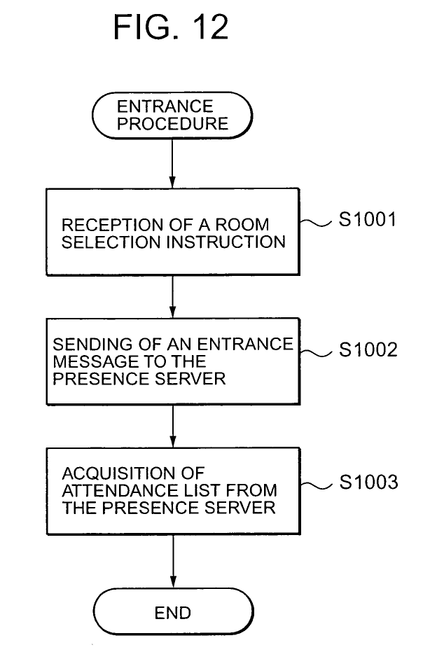

FIG. 12 shows a processing procedure of the client 201 at the time when the user selects a room that he wishes to enter out of the room list shown on the display 220. The presence provider 222 of the client 201 receives a room selection instruction inputted through the pointing device 226 (S1001). Then the presence provider 222 sends an entrance message (enter) to the presence server 110 (S1002). The entrance message includes the identification information of the user of the client 201, the positional information and directional information of the user in the virtual space, and the aura size stored in the local policy 224. It is assumed that the positional information and directional information of the user at the time of entrance are previously stored in the memory 302 or the external storage 303.

Or, a SUBSCRIBE message of SIP may be used for sending an entrance message. Namely, a SUBSCRIBE message whose recipient is the selected room is used as an entrance message. A SUBSCRIBE message requests notification of an event (for example, entrance, exist or movement of a user, or a change in the properties of the virtual space) occurred in the virtual space of the selected room.

Next, the presence provider 222 receives an attendance list listing users (other then the user of the client 201 itself) who exist in the selected room, from the presence server 110 (S1003). When a SUBSCRIBE message is used as the entrance message, the attendance list in the form of a NOTIFY message corresponding to the SUBSCRIBE message is sent to the presence provider 222. It is assumed that the attendance list includes at least information on the users in the room other than the user of the client 201 itself and virtual space properties of the designated room.

For each user other than the user of the client 201 itself, the information on that user includes identification information, positional information and directional information of that user in the virtual space, and the aura size stored in the local policy 224 of that user. The virtual space properties include information on non-user information sources (such as Internet Radio, Internet Television, and the like). For each information source located in the virtual space, the information on that information source includes the information source identification information for identifying the information source, the installation location in the virtual space, the best area (a certain place in the virtual space) for a user to watch or listen the information source in question, and the like. The presence provider 222 stores the information included in the received attendance list into the memory 302 or the external storage 303.

After the above-described entrance processing, the audio communication unit 215 and the video communication unit 218 receive multimedia data such as a voice or a moving picture from the streaming server 140, using RTP (Real-time Transport Protocol). Further, using RTP, the audio communication unit 215 and the video communication unit 218 send and receive voices and/or images of the other users existing in the room and the voice and image of the user of the client 201 itself to and from the clients of the other users.

Although a processing procedure when a user to exits a room is not shown, the presence provide 222 receives an exit instruction from the user and sends an exit message including the user identification information to the presence server 110.

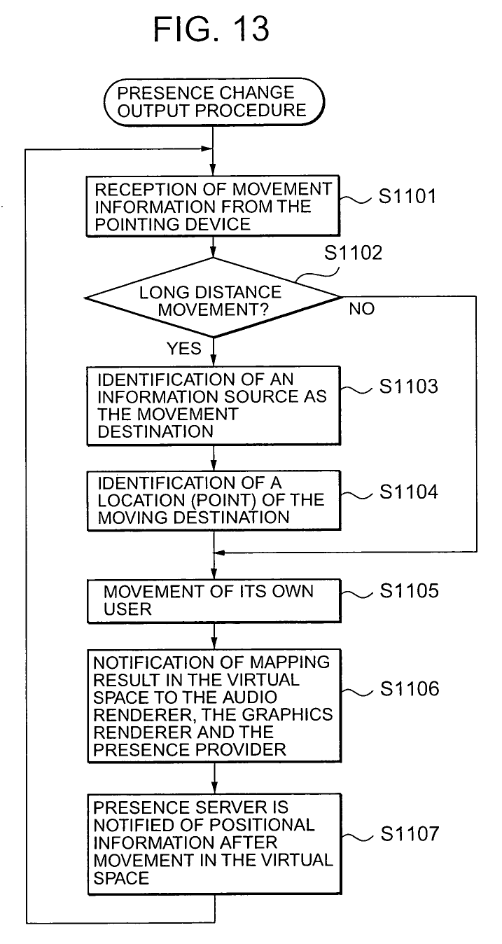

FIG. 13 shows a procedure to be performed in the case where the user changes his presence, i.e., changes his location or direction in a virtual space. First, the space modeler 221 receives input of movement information from the pointing device 226 (S1101). The space modeler 221 judges whether the received movement information means a long distance movement or not (S1102). Namely, when a long push of the forward movement button 231, the backward movement button 232, the leftward movement button 233 or the rightward movement button 234 is received, the space modeler 221 judges that the inputted movement information means a long distance movement. Or, when input of continuous coordinates of a line segment that is longer than the prescribed length in a certain direction is received from the touch panel, the space modeler judges that the inputted movement information means a long distance movement.

In the case where the movement information is judged to be a long distance movement (S1102: yes), the space modeler 221 identifies the information source as the movement destination (S1103). For example, in the case of a long push of the forward movement button 231, the space modeler 221 identifies a user or a non-user information source that exists in front of and closest to the user of the client 201 itself (See FIG. 9). Or, in the case of a long push of the leftward movement button 233, the space modeler 221 identifies a user or a non-user information source that exists within a certain rage and in the direction of the least rotation angle for counterclockwise rotation (See FIG. 10).

Then, the space modeler 221 specifies a location (a point) as the movement destination of its own user (S1104). Namely, in the case where the identified information source is another user than its own user, the space modeler 221 compares the aura size (which is included in the attendance list received in the entrance procedure (See S1003 of FIG. 12) of that user with the aura size (which is stored in the local policy 224) of its own user. Then the space modeler 221 identifies the aura of the larger size and specifies a point at which the identified aura collides with the user of the client itself (or a point at which the aura of the user of the client itself collides with the identified user).

Or, in the case where the identified information source is a non-user information source (such as Internet Radio, or the like), the space modeler 221 specifies some point within the listening or watching area (which is included in the virtual space properties in the attendance list (See S1003 of FIG. 12)) of the identified information source.

Then the space modeler 221 moves its own user to the specified location (point), i.e., the movement destination of that user (S1105). Further, in the case where the movement information does not means a long distance movement (S102: No), the space modeler 221 moves its own user according to the movement information inputted. For example, in the case where a short push of the forward movement button 231 is received, the space modeler 221 moves its own user forward by a prescribed distance. In the case where input of the leftward movement button 233 is received, the space modeler 221 turns its own user counterclockwise through a prescribed angle, to change his direction.

Then, the space modeler 221 stores the location and direction (hereinafter, referred to as positional information and the like) of its own user after the movement into the memory 302 or the external storage 303 (hereinafter, referred to as the memory or the like).

Next, the space modeler 221 notifies the audio renderer 216, the graphics renderer 219 and the presence provider 222 of the positional information and the like of the virtual space after the movement (S1106). As described referring to FIG. 5, the audio renderer 216 calculates how voice or music of each information source is heard at the location and direction of its user in the virtual space. Then, based on the calculation, the audio renderer 216 performs processing such as volume control, reverberation, filtering and the like on each information source's voice or music outputted from the audio communication unit 215. Thus, the audio renderer 216 controls sound effects to obtain sound to be heard at the location of its own user in the virtual space and updates the three-dimensional sound.

Further, the graphics renderer 219 changes the viewpoint of its user based on the location and direction of the user in the virtual space, and calculates how each information source is seen in the virtual space (coordinate transformation) (See FIGS. 6 and 7). Then, the graphics renderer 219 generates image data to output on the screen as a view seen from that location and in that direction, and updates the display screen.

Next, the presence provider 222 notifies the presence server 110 of the positional information and the like of its own user in the virtual space after the movement (S1107). In the case of using the SIP protocol, a NOTIFY message is used. A NOTIFY message is usually sent as a result of receiving a SUBSCRIBE message. Thus, it is considered that, when the presence server 110 receives an entrance message from the client 201, the presence server 110 sends the attendance list together with a SUBSCRIBE message corresponding to the above-mentioned NOTIFY message. The presence server 110 receives the positional information and the like of the virtual space, which have been notified from the presence provider 222, and updates the positional information and the like of the user in question in the attendance list.

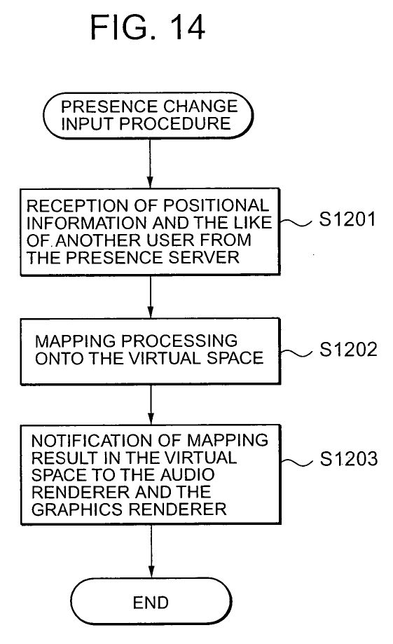

FIG. 14 shows a presence change input procedure, i.e., a procedure to be performed in the case where the presence server 110 notifies the client 201 of the positional information and the like of another user in the virtual space.

The space modeler 221 receives the positional information and the like of a user of another client from the presence server 110 through the presence provider 222 (S1201). The presence server 110 notifies (sends) the positional information and the like sent from the client 201 in S1107 of FIG. 13 to the other clients than the client 201, i.e., the sender. Then the space modeler 221 stores the notified positional information and the like of the virtual space into the memory or the like. Then the space modeler 221 uses the notified positional information and the like to change the locations and directions of the other users in the virtual space. Then, the space modeler 221 notifies the audio renderer 216 and the graphics renderer 219 of the positional information of the virtual space after the movement (S1203). As described with respect to S1106 of FIG. 13, based on the notified location and direction of another user, the audio renderer 216 and the graphics renderer 219 update the three-dimensional sound of that user and the display screen.

Next, will be described a functional configuration and processing procedures of the presence server 110. The registration server 130 and the SIP proxy server 120 are similar to ones in the conventional communication using SIP, and their description is omitted here.

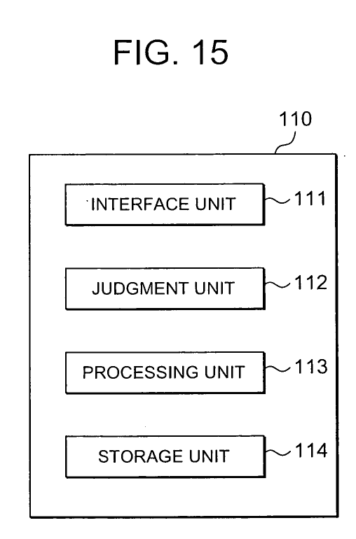

FIG. 15 shows a functional configuration of the presence server 110. The presence server 110 comprises an interface unit 111 for sending and receiving various pieces of information to and from a client, a judgment unit 112 for judging a type of a message from a client, a processing unit 113 for performing processing corresponding to the judgment result, and a storage unit 114 for managing and storing properties of a virtual space, events (entrances, exits, movements and the like of users) that have occurred in the virtual space, a room list, an attendance list, and the like.

The storage unit 114 stores in advance properties of some virtual spaces managed by the presence server 110. As described above, a user selects a virtual space that he wishes to enter, out of those virtual spaces (See FIGS. 11 and 12). Thereafter, the client sends various events of the user who enters the virtual space to the presence server 110. As a result, various events occur in each virtual space. The storage unit 114 stores the above-mentioned information into the memory 302 or the external storage 303.

The properties of a virtual space include information on non-user information sources. A system administrator of the present system determines in advance respective virtual spaces in which the non-user information sources are installed, respective locations at which the non-user information sources are located, and respective places in the virtual spaces at which the listening or watching areas of the non-user information sources are defined. The administrator inputs these pieces of information through the input unit 305 to store the information into the storage unit 114. For example, it is considered to determine the installation locations of the non-user information sources in the virtual spaces, based on characteristics of broadcasting stations or contents of programs broadcast by each broadcasting station.

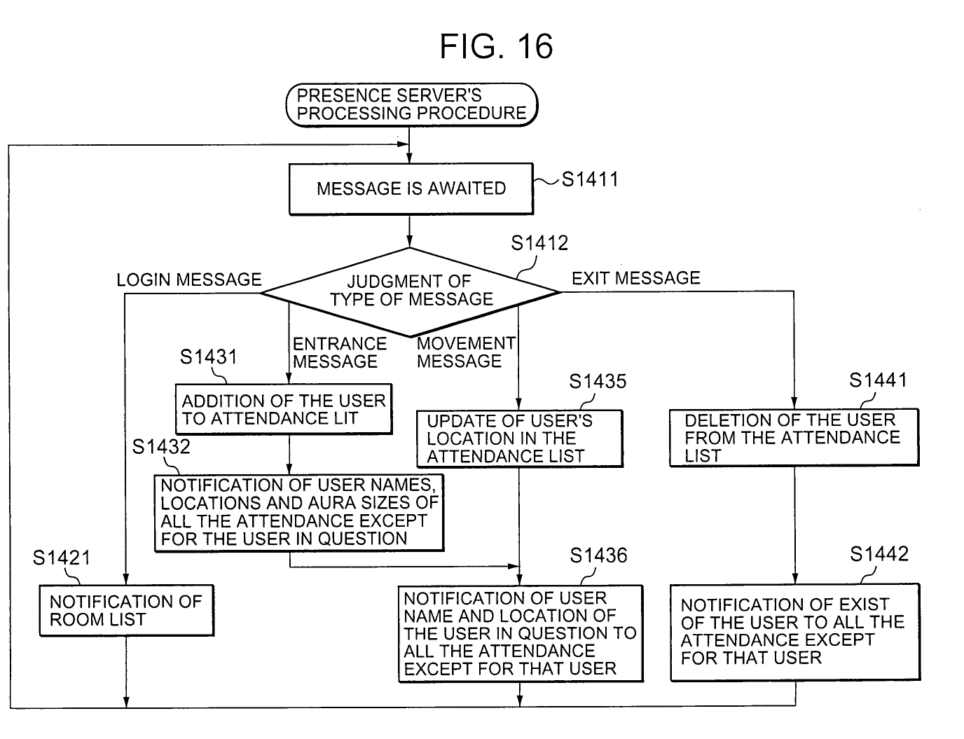

FIG. 16 shows a processing procedure of the presence server 110. The presence server 110 receives a request from a client and performs processing of the request, until the presence server 110 is stopped. First, the interface unit 111 awaits a message from a client (S1411). When a message is received, then the judgment unit 112 judges a type of the message received by the interface unit 111 (S1412).

In the case where the message is a login message, the processing unit 113 instructs the interface unit 111 to send the room list to the client as the message source (S1421). The interface unit 111 sends the room list to the client as the message source. Thereafter, the procedure returns to S1411, to await a next message.

In the case where the message is an entrance message, the processing unit 113 adds the user of the client as the message source to the attendance list of the designated room (S1413). Namely, the processing unit 113 adds the identification information of that user and the positional information and directional information of that user in the virtual space and the size of the aura of that user (these pieces of information are included in the entrance message) to the attendance list. Next, the processing unit 113 instructs the interface unit 111 to send the identification information, the positional information and directional information in the virtual space, and the sizes of the auras of all the attendance (except for the user in question) of the designated room to the client as the message source.

Further, the processing unit 113 instructs the interface unit 111 to send the virtual space properties of the designated room to the client as the message source. The virtual space properties include the information on each information source installed in the virtual space. According to above instructions, the interface unit 111 sends those pieces of information to the client as the message source (S1432). Then, the procedure goes to S1436 described below.

In the case where the message is a movement message, the processing unit 113 updates, in the attendance list, the positional information and directional information of the client (the user) as the massage source in the virtual space (S1435). The positional information and directional information in the virtual space are included in the movement message. Then, the processing unit 113 instructs the interface unit 111 to notify the identification information and the positional information and the directional information of the user of the client as the message source in the virtual space to the clients of all the attendance of the room concerned (except for the client as the message source) (S1436). According to the instruction, the interface unit 111 sends these pieces of information to the clients, and the procedure returns to S1411. This is same with the case of the entrance message (S1431).

In the case where the message is an exit message, the processing unit 113 deletes the user of the client as the message source from the attendance list (S1441). Then, the processing unit 113 instructs the interface unit 111 to notify the clients of all the attendance of the room concerned (except for the client as the message source) of the exit of the user from the room (S1442). According to the instruction, the interface unit 111 sends the information to the clients, and the procedure returns to S1411.

Although not shown, the presence server 110 may receive a request (input) from the system administrator, to change the virtual space properties. For example, the judgment unit 112 receives an information source adding instruction inputted through the input unit 305 of the presence server 110. This information source adding instruction includes identification information for identifying a room as an object of the change, and the identification information, installation location and listening or watching area of the information source to be added. Then, the processing unit 113 adds the new information source to the virtual space properties (which are stored in the storage unit 114) of the room as the object of the change. Then the processing unit 113 reads the attendance list stored in the storage unit 114 and notifies the clients of all the users existing in the room as the object of the change, of the virtual space properties after the change (addition of the information source). The space modeler 221 of each client which has received the notification stores the virtual space properties after the change into the memory or the like. The audio renderer and the graphics renderer output the audio signal and video signal of the new information source, which are distributed by the streaming server 140.

Next, will be described a functional configuration of the streaming server 140.

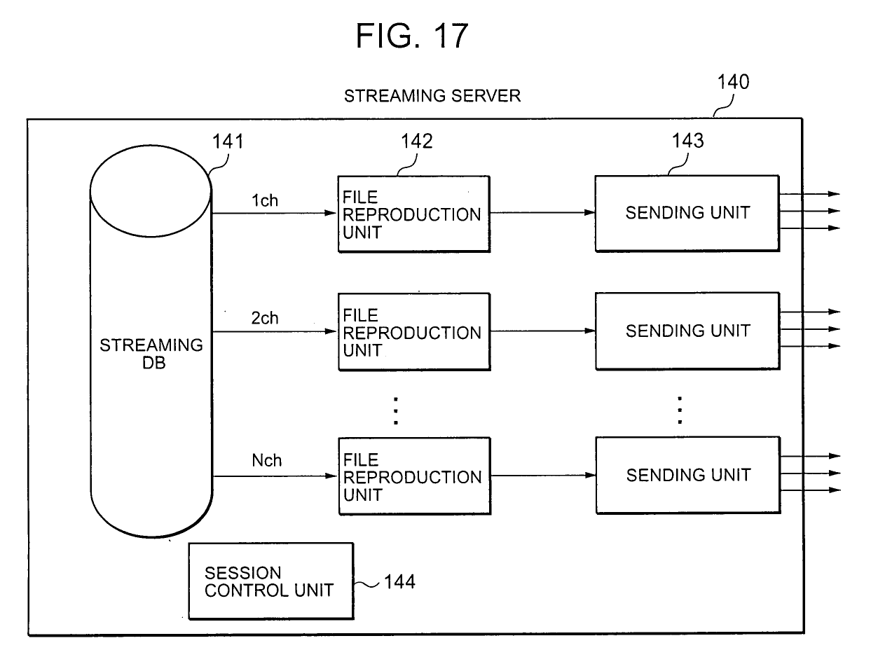

FIG. 17 shows a functional configuration of the streaming server 140. As shown in the figure, the streaming server 140 comprises a streaming DB 141, at least one set of a file reproduction unit 142 and a sending unit 143, and a session control unit 144. Namely, the streaming server 140 has sets of a file reproduction unit 142 and a sending unit 143 as many as the number of channels of broadcasting stations. Or, the streaming server 140 may realize each type of units (the file reproduction units 142 or the sending units 143) by using one program or one apparatus in the time division manner, without actually having as many as the number of the channels.

The streaming DB 141 is a database (file) storing multimedia data such as voice data or moving picture data. For each channel, the corresponding file reproduction unit 142 takes out an MP3 format signal (file), a non-compressed music signal, an MPEG format signal (file) and a non-compressed moving picture signal stored in the streaming DB 141. Then, the file reproduction unit 142 sends the taken-out signals (files) to the corresponding sending unit 143, after expanding, if any, compressed signals. The sending unit 143 sends the signals inputted from the file reproduction unit 142 to all the clients existing in the virtual space. The session control unit 144 controls communications with the SIP proxy server 120 and the clients.

The session control unit 144 of the streaming server 140 receives a communication start (INVITE) message from a client through the SIP proxy server 120. In the case where the communication start message in question is the first one (i.e., there is no client that is sending a voice or image yet), the file reproduction unit 142 starts reproducing the files stored in the streaming DB 141. The corresponding sending unit 143 sends the contents of the reproduced file to the client as the sender of the communication start message, using the session control unit 144. Or, in the case where a new communication start message is received while a communication start message has been already received from another client and the file contents reproduced by the file reproduction unit 142 are being sent to that client, the sending unit 143 sends the same file contents reproduced by the file reproduction unit 142 to the client as the sender of the new communication start message, using the session control unit 144.

The audio communication unit 215 and the video communication unit 218 of each client receive a signal for each channel from the streaming server 140. Then, based on the virtual space properties stored in the memory or the like, the audio renderer 216 and the graphics renderer 219 identifies a signal corresponding to each information source installed in the virtual space, and outputs (reproduces) the identified signal at the installation location of that information source.

Hereinabove, one embodiment of the present invention has been described.

According to the communication system of the above-described embodiment, it is possible to select any information source among a plurality of information sources such as the other users than the user of the client concerned, Internet Radio, and the like existing in a virtual space, and to move the user of the client in question to a location at a suitable distance from (or close to) the selected information source. As a result, it is possible to listen the voice of the selected information source predominantly, in the state that voices from the other information sources existing in the virtual space can be heard.

Further, in the case where a user moves toward an information source such as another user, Internet Radio, or the like existing in a virtual space, it is possible for the user to move easily to a suitable location depending on that information source. As a result, a handicapped person having trouble with his hand or an old man can give an instruction of movement in the virtual space easily.

In the present embodiment, a plurality of information sources exist in one virtual space. Namely, a user can watch and/or listen a plurality of information sources all at once. As a result, a user can easily find another user with whom he wishes to have a conversation or radio or television that he wishes to listen or watch, out of a plurality of information sources existing in a virtual space. For example, it is possible to listen or watch programs of all or some of the radio or television channels at once, or to catch a keyword or a topic coming from a program, while paying attention to another program. Sometimes, a user judges that a program of a different information source is better than a program of an information source to which he is paying attention now. In that case, the user can approach the information source that he judges better, to switch his attention to the program of—that information source without stopping listening or watching the program of the information source to which he is paying attention now. Further, it is possible to listen or watch all the programs of all the radio and television channels at once. Further, it is possible to listen or watch one or more programs of one or more information sources, while having a conversation with another user.

According to the present embodiment, differently from the conventional conference systems, even when a plurality of information sources (such as a group of users other than the user of the client concerned) are having conversations over different topics at the same time, the user of the client in question can select a voice of a specific information source by moving in the virtual space or by paying his attention only to the voice coming from a specific direction. The conventional conference systems do not consider selection of a specific information source out of a plurality of information sources, and thus, it is difficult to select a specific user out of a plurality of users when those users speak at the same time.

The present invention is not limited to the above-described embodiment, and can be varied variously within the scope of the invention.

For example, the client 201 of the above embodiment is provided with the camera 213, the video encoder 214, and the like, and outputs image data of a virtual space to the display 220. However, it is possible that a user grasps directions and distances of information sources by means of three-dimensional voice outputted from the headphones 217 according to the three-dimensional audio technique, and gives an instruction of his movement in a virtual space using the operating buttons 231-234 without seeing the display 220. In this case, the client 201 does not output image data of a virtual space to the display 220. Accordingly, the client 201 does not have the camera 213, the video encoder 214, the display 220, and the like.

Further, when a touch panel is used to give an instruction of a movement of its own user, a point to which the user wishes to move may be designated by touching the location of that point by his finger. The touch panel detects the location (coordinates) touched by the finger on the screen, and inputs the location to the space modeler 221. The space modeler 221 continuously moves its own user to a virtual space location corresponding to the inputted location on the screen. Thus, the user is not moved directly to the object location, for fear that abrupt movement will give rise to confusion in senses including hearing senses of its own user and the other users. In the case of continuous and not too rapid movement, the user can move while keeping his senses at the current location. In that case, the space modeler 221 calculates user's path from the current location to the designated location reached by the movement, to move the user continuously. Namely, the space modeler 221 selects a path that does not run through neighborhoods of the other users (including their auras) and obstacles, among a straight line segment and curved lines connecting the current location and the designated location. When the straight line segment connecting the current location and the designated location does not run through neighborhoods of the other users and the obstacles, the space modeler 221 selects the line segment as the path, and moves its own user to the designated location along the path at a constant speed. In the case where the line segment connecting the current location and the designated location runs through neighborhoods of the other users and obstacles, the space modeler 221 selects a certain number of points that exist within a certain range from the above-mentioned line segment and can be passed through (i.e., points where another user or an obstacle does not exist). Then, the space modeler 221 calculates a spline curve passing through the selected points that can be passed through. The space modeler 221 moves the user to the designated location along the calculated spline curve at a constant speed

[symbol]

In the case where it is impossible to move to the designated location without running through neighborhoods of the other users and obstacles, the space modeler 221 outputs an error message of voice that reports a failure of the movement, to the headphones 217 or the like. As a result, the user can know that he has failed in movement.

Further, in the above embodiment, the system administrator determines respective virtual spaces in which information sources are installed, and respective locations at which the information source are located. However, it is possible to determine installation locations of information sources automatically, based on characteristics of broadcasting stations or contents of programs broadcast now by each broadcasting station. For example, it is possible to consider a method in which characteristics of each broadcasting station or contents of programs broadcast by each broadcasting station are described as a group of keywords, and these keywords are inputted into a neural net to generate a two-dimensional topological map, and sound sources are arranged in respective areas of the topological map.

Further, in the present embodiment, a user listens or watches voices or images of a plurality of information sources, depending on the user's location and direction in a virtual space. However, it is possible that a user selects a desired information source out of a plurality of information sources of Internet Radio and Internet Television and listens or watches only the voice or image of that desired information source by approaching to that information source. For example, it may be assumed that, when a user moves into a listening or watching area as the best area for listening or watching an information source of Internet Radio or Internet Television in a virtual space, the user can listen or watch only the voice or image of that information source. Namely, when a user moves into a listening or watching area of some information source, the audio communication unit 215 and the video communication unit 218 disconnects (i.e., ends communications of) audio signals and video signals of the other information sources than the information source in question. The audio renderer 216 and the graphics renderer 219 perform rendering of only the voice or image of the information source in question, to output it to the headphones 217 or the display 220. As described above, the listening or watching area is one piece of information (on an information source) included in the virtual space properties.

Further, in the above embodiment, the information sources other than the users (non-user information sources) are described taking an example of Internet Television or Internet Radio. However, non-user information sources may be radio programs of ordinary radio broadcasting. Namely, each radio program broadcast on its frequency is taken as one information source, and a plurality of information sources as programs on a plurality of frequencies are arranged in a virtual space. In the case where a radio program is taken as an information source, the audio communication unit 215 shown in FIG. 2 receives the radio program broadcast from a radio station not shown. Then, the audio communication unit 215 transforms voice or music of the received radio program into a digital signal and outputs the digital signal to the audio renderer 216. In the case of ordinary radio broadcasting, it is possible to listen only one station at once. Accordingly, it takes time to find a desired program, using a dial or selection button to change a frequency one by one. However, as described above, by arranging a plurality of radio program broadcast on respective frequencies as a plurality of information sources in a virtual space, it is possible to listen radio programs broadcast on a plurality of frequencies, at the same time.

Further, in the present embodiment, the presence server 110 manages locations of information sources in a virtual space and the virtual space properties. However, each client may have the functions of the presence server 110. Namely, each client directly exchanges information on locations and directions of its own user and the other users in a virtual space, among all the clients. And, each client shares the information on the locations and directions of all the users. Further, it is assumed that each client has the information of the virtual space properties. In this case, the presence server 110 is not required. In detail, respective presence providers 222 (See FIG. 3) of clients directly communicate with one another not through the presence server 110. In this method, each client should know the addresses of all the other clients. To know the addresses of all the other clients, there is a method in which, as for each client, the addresses of all the other client than that client are previously registered at that client. Otherwise, there is a well known method of using, for example, the protocol JXTA (http://www.jxta.org/) to find another client among clients (i.e., through peer-to-peer communication).

In the above embodiment, each client directly performs voice communication and modifies voices inputted from the other clients into three-dimensional ones (See FIG. 5). However, in the case where processing and communication performances of clients are lower, such processing may be performed by a server. Namely, a sound server may be added newly to the network configuration shown in FIG. 1. Further, in the present embodiment, each client directly receives an audio signal or a video signal from the streaming server 140 and outputs the received at a certain location in a virtual space. However, such processing may be performed by the streaming server 140. In the following, will be described embodiments in which a server performs rendering.

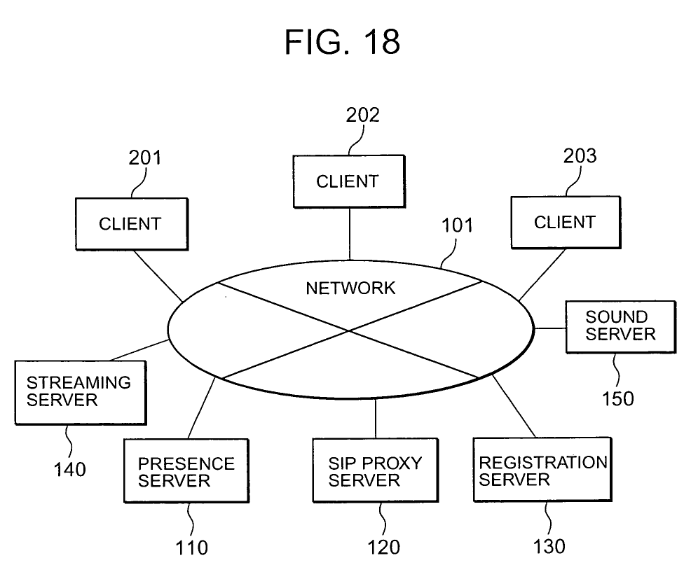

FIG. 18 is a diagram showing a network configuration of an embodiment having a sound server 150. The network configuration shown in the figure is different from the network configuration of FIG. 1 in that the sound server 150 exists in the network configuration. Further, each of the clients 201, 202 and 203 has a different configuration from the client shown in FIG. 3 in the following points. Namely, the audio renderer 216 is a simple sound decoder that does not perform three-dimensional processing of sound (See FIG. 6). Further, the audio communication unit 215 communicates with the sound server 150, without directly communicating with another client.

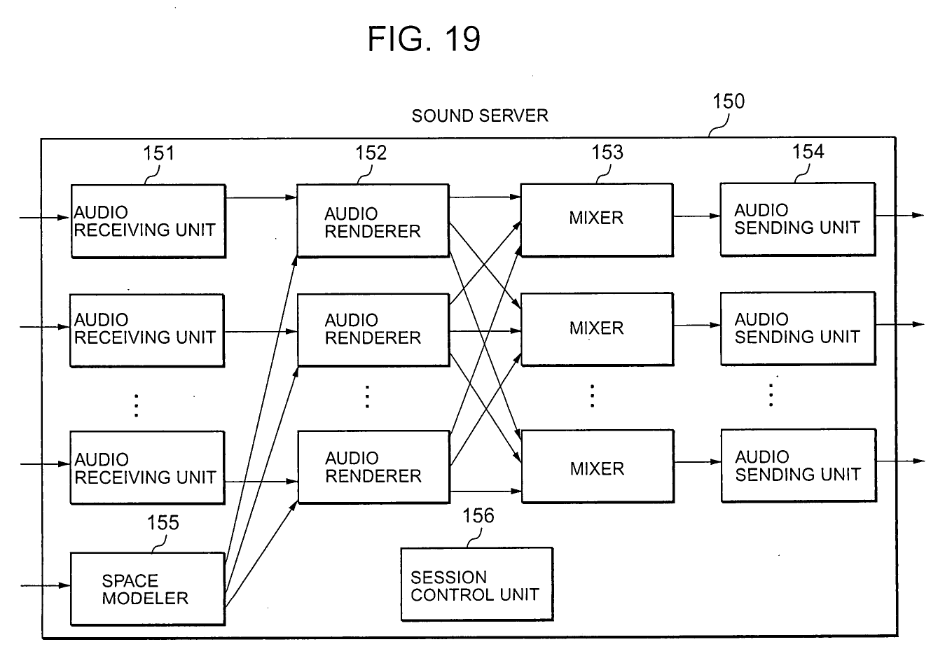

FIG. 19 is a block diagram showing a configuration of the sound server 150 of FIG. 18. As shown in the figure, the sound server 150 comprises one or more audio receiving units 151, one or more audio renderers 152, one or more mixers 153, and one or more audio sending units 154. Namely, the sound server 150 has these processing units 151-154, correspondingly to the number of clients (namely, one set of processing units 151-154 for each client). Or, without actually having the audio receiving units 151, the audio renderers 152, the mixers 153 and the audio sending units 154 correspondingly to the number of the clients, but the sound server 150 may realize each type of units by using one program or one apparatus in the time division manner.

Further, the sound server 150 further comprises a space modeler 155. The space modeler 155 receives a location of each user in a virtual space and the properties of the virtual space from the presence server 110, and maps (locates) the location of each user onto the virtual space by processing similar to the processing of the space modeler 221 of the client shown in FIG. 3. Further, the sound server 150 further comprises a session control unit 156. The session control unit 156 controls communication with another apparatus, through the network 101.

Each audio receiving unit 151 receives voice inputted from the audio communication unit 215 of each client. The corresponding audio renderer 152 performs three-dimensional processing of the voice, and outputs two-channel (left and right channels) signal data (a signal string) corresponding to each client to the mixer 153 associated with that client. Namely, based on the location of each user arranged in the virtual space by the space modeler 155, each audio renderer 152 performs processing similar to the processing by the audio renderer 21 of the client shown in FIG. 3, i.e., reception of sound source input (S61 of FIG. 5), calculation of a distance and an angle (S62), specifying of HRIR (S63) and convolution calculation (S64 and S66). Each mixer 153 receives two-channel signal data from each audio renderer 152, and performs processing similar to the processing of the audio renderer 216 of the client shown in FIG. 3, i.e., mixing (S65 and S67) and reverberation calculation (S68 and S69). Then, each mixer 153 outputs two-channel signal data to the corresponding audio sending unit 154. Each audio sending unit 154 sends the received signal data to the corresponding client.

Next, will be described processing in the sound server 150. Each audio receiving unit 151 associated with a client receives and buffers a voice stream from that client, and sends signal data synchronized (associated) with voice streams of all the other input clients to the audio renderer 152 associated with that client. A method of this buffering (Play-out buffering) is described in the following document, for example.

Colin Perkins: RTP: Audio and Video for the Internet, Addison-Wesley Pub Co; 1st edition (Jun. 11, 2003).

Then, based on the location of each user arranged in the virtual space by the space modeler 155, each audio renderer 152 performs the processing of distance/angle calculation, specification of HRIR and convolution calculation (S62-S64 and S66 in FIG. 6). Then each mixer 153 performs the mixing (S65 and S67 in FIG. 5) and the reverberation calculation (S68 and S69 in FIG. 5), and outputs two-channel signal data corresponding to the client concerned. Each audio sending unit 154 sends the signal data to the client concerned. Thus, even in the case where processing performances of clients are low, it is possible to realize three-dimensional voice processing.

Further, the presence server have the functions of the above-described sound server 150. In other words, without providing a sound server 150 separately, the presence server 110 not only manages the locations of the users, the virtual space properties, and the like, but also performs the above-described processing of the sound server 150.

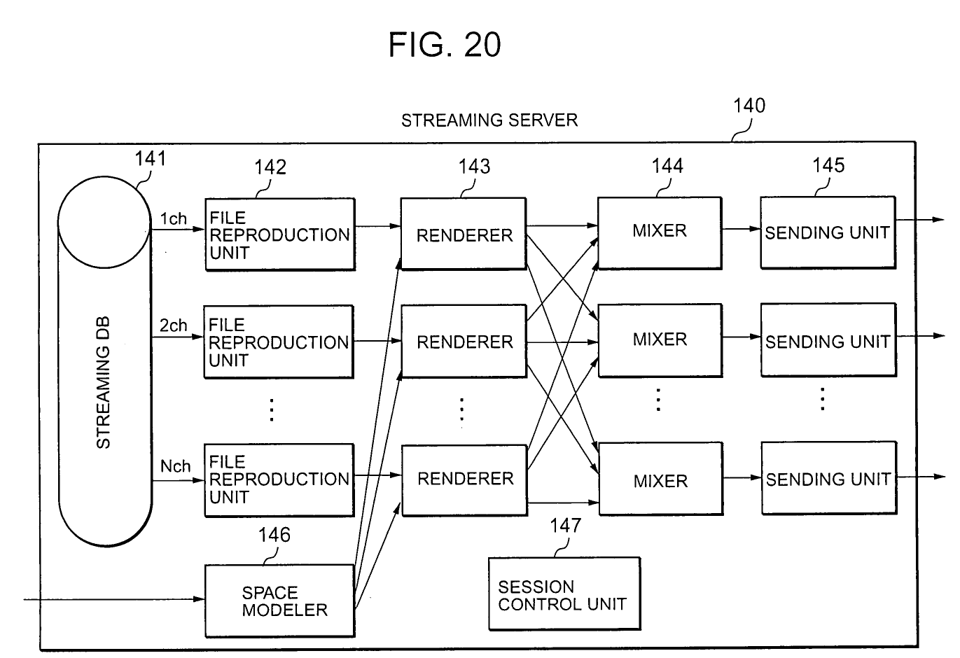

FIG. 20 is a diagram showing a functional configuration of the streaming server 140 shown in FIG. 18. As shown in the figure, the streaming server 140 comprises a streaming DB 141, one or more file reproduction units 142 and one or more renderers 143 (respectively corresponding to channels), a space modeler 146, and session control unit 147. The streaming server 140 further comprises mixers 144 and sending units 145 respectively corresponding to clients. The streaming DB 141 and the file reproduction units 141 are similar to the streaming DB 141 and the file reproduction units 141 shown in FIG. 17. The space modeler 146 and the session control unit 147 are similar to the space modeler 155 and the session control unit 156 shown in FIG. 19. Here, without providing the file reproduction units 142, the renderers 143, the mixers 144 and the sending units 145 correspondingly to the number of the channels or the number of the clients, each type of units may be realized by using one program or one apparatus in the time division manner.

Based on locations and directions of the users in the virtual space, each renderer 143 performs, for each client, rendering of an audio signal or video signal reproduced by the corresponding file reproduction unit 142. As for an audio signal, each renderer 143 performs processing similar to the processing of the audio renderer 216 shown in FIG. 3. Namely, based on the location and direction received from the presence server 110, each renderer 143 performs processing of the file (audio signal) reproduced by the corresponding file reproduction unit 142, using the three-dimensional audio technique and depending on the virtual space properties such as reverberation, filtering and the like. Further, as for a video signal, each renderer 143 performs processing similar to the processing of the graphics renderer 219 shown in FIG. 3, and further performs the following processing. Namely, since resolution required by each client is lower than an input video signal, each renderer lowers resolution. For example, with respect to an image to be displayed in ¼ of the size of the display 220 in a client, a renderer 143 lowers the resolution of the image to ¼. Further, to reduce the processing load on the side of a client, with respect to an image to be displayed obliquely on the display 220 of the client, it is considered that the renderer 143 previously transforms the image to have that shape.

As for an audio signal, each mixer 144 performs processing similar to the processing of the audio renderer 216 shown in FIG. 3. Namely, each mixer 144 adds inputted signals. Further, as for a video signal, each mixer 144 integrates input signals into one signal of a unified format so that the corresponding sending unit 145 can easily treat the signal. Namely, in the case of a video signal, each mixer 144 inserts the video signal into a certain location of a virtual space from the viewpoint based on the location and direction of each user in the virtual space, to generate moving picture data of the virtual space.

Each sending unit 145 compresses a voice signal or image signal generated by the mixer 144 for each client, and sends the compressed signal to that user. For example, in the case of a voice signal the sending unit 146 encodes the signal into MP3, and in the case of an image signal into MPEG, before sending. The audio renderer 216 and graphics renderer 219 of each client expands the MP3 or MPEG format compressed data received from the streaming server 140, and outputs the expanded data to the headphones 217 or the display 220.

Next, will be described processing by the presence server 110 and the clients. When the presence server 110 notifies each client of a user name (or names) and a location and aura size (or locations and aura sizes) of the user (or users) concerned in the steps S1432, S1436 and S1442 of FIG. 16, the presence server 110 also notifies the sound server 150 and the streaming server 140 of these user name(s), location(s) and aura size(s). The session control unit 156 of the sound server 150 and the session control unit 147 of the streaming server 140 receive the user name(s), the location(s) and aura size(s) of the user(s) from the presence server 110. As a result, when each client enters a room, the client can perform voice communication with a prescribed communication port (or a port notified from the presence server 110 at the time of entrance) of the sound server 150. Namely, the audio communication unit 215 of each client sends a one-channel voice stream to the sound server 150 and receives two-channel voice streams from the sound server 150. Further, when each client enters a room, the client receives an audio signal and video signal of each channel from the streaming server 140.

1. An information source selection system that selects an arbitrary information source out of a plurality of information sources, using a virtual space, wherein:
said virtual space includes said plurality of information sources;
said information source selection system comprises a server apparatus that manages locations of said plurality of information sources in the virtual space and a client terminal;
said client terminal comprises:
a movement receiving means that receives a movement instruction on a movement of a user of the client terminal in the virtual space;
a moving means that moves the user in the virtual space, according to the movement instruction received by said movement receiving means;
a client sending means that sends positional information on a location of the user moved by said moving means in the virtual space to said server apparatus;
a client receiving means that receives positional information on a location of each of said plurality of information sources in the virtual space from said server apparatus;
a space modeling means that calculates the location of said user and the locations of said plurality of information sources in the virtual space, based on said positional information on the location of said user in the virtual space and said positional information on the location of each of said plurality of information sources in the virtual space; and
a sound control means that controls sound effects applied to a voice of each of said plurality of information sources, based on the locations calculated by said space modeling means; and
said server apparatus comprises:
a server receiving means that receives said positional information on the location of said user in the virtual space from said client terminal;
a storing means that stores said positional information (which is received by said server receiving means) on the location of the user in the virtual space and the positional information of the locations of said plurality of information sources in the virtual space; and
a server sending means that sends said(?) positional information (which is stored in said storing means) on the locations of said plurality of information sources to said client terminal.

2. An information source selection system according to claim 1, wherein:
said information source selection system further comprises a streaming server that distributes voice data and/or moving picture data to said client terminal; and
the voice data and/or moving picture data distributed by said streaming server are among said plurality of information sources.

3. An information source selection system according to claim 2, wherein:
said storing means of said server apparatus stores virtual space properties that includes places at which said voice data and/or moving picture data among said plurality of information sources are arranged in the virtual space;
said server sending means sends said virtual space properties to said client terminal;
said client receiving means receives said virtual space properties from said server apparatus;
said space modeling means calculates a location of each of the voice data and/or moving picture data among said plurality of information sources in the virtual space, based on said virtual space properties; and
said sound control means controls sound effects applied to a voice of each of the voice data and/or moving picture data among said plurality of information sources, based on the locations calculated by said space modeling means.

4. An information source selection system according to claim 1, wherein:
said client terminal further comprises an image generation means that generates image data to be outputted onto a display screen, based on the locations calculated by said space modeling means.

5. An information source selection system according to claim 4, wherein:
said image generation means generates the image data in which the location and a direction of the user are always fixed in the virtual space, and said virtual space and said plurality of information sources are moved or turned relatively to and centering at said user.

6. An information source selection system according to claim 1, wherein:
said information source selection system further comprises a identifying means that identifies an information source as a moving destination, based on the movement instruction received by said movement receiving means; and
when said movement instruction means a long distance forward movement;
said identifying means identifies an information source existing closest to and in front of said user in the virtual space; and
said moving means moves the user close up to the information source identified by said identifying means.

7. An information source selection system according to claim 1, wherein:
said information source selection system further comprises a identifying means that identifies an information source as a moving destination, based on the movement instruction received by said movement receiving means; and
when said movement instruction means a long distance backward movement;
said identifying means identifies an information source existing closest to and in a rear of said user in the virtual space; and
said moving means moves the user close up to the information source identified by said identifying means.

8. An information source selection system according to claim 1, wherein:
said information source selection system further comprises a identifying means that identifies an information source as a moving destination, based on the movement instruction received by said movement receiving means; and
when said movement instruction means a long distance leftward movement;
said identifying means identifies an information source having a smallest counterclockwise rotation angle from a direction of said user among information sources existing within a prescribed range from the location of said user in the virtual space; and
said moving means moves the user close up to the information source identified by said identifying means.

9. An information source selection system according to claim 1, wherein:
said information source selection system further comprises a identifying means that identifies an information source as a moving destination, based on the movement instruction received by said movement receiving means; and
when said movement instruction means a long distance rightward movement;
said identifying means identifies an information source having a smallest clockwise rotation angle from a direction of said user among information sources existing within a prescribed range from the location of said user in the virtual space; and
said moving means moves the user close up to the information source identified by said identifying means.

10. An information source selection system according to claim 1, wherein:
other users existing in the virtual space are among said plurality of information sources;
each of said user and said other users has a predetermined certain area centering at the user in question;
said information source selection system further comprises an identifying means that identifies an information source as a moving destination, based on the movement instruction received by said movement receiving means;
when the information source identified by said identifying means is one of said other user, said moving means compares a size of the area of said user and a size of the area of said identified one of the other users;
when the area of said one of the other users is larger, said user is moved to a point at which said user collides with the area of said one of the other users; and
when the area of said user is larger, said user is moved to a point at which the area of said user collides with said one of the other users.

11. An information source selection system according to claim 1, wherein:
when a left-right direction length of a line segment received by said movement receiving means as a movement instruction is larger than a front-back direction length of said line segment, then said moving means judges that said movement instruction means a leftward or rightward movement, and moves said user leftward or rightward;
when the front-back direction length of said line segment received as the movement instruction is larger than the left-right direction length of said line segment, then the movement receiving means judges that said movement instruction means a forward or backward movement, and moves said user forward or backward.

12. An information source selection system according to claim 11, wherein:
said information source selection system further comprises an identifying means that identifies an information source as a moving destination, based on the movement instruction received by said movement receiving means;
in the case where said movement instruction is judged to mean a leftward or rightward movement;
when the left-right direction length of the line segment as the movement instruction is larger than a prescribed length, then said identifying means identifies an information source having a smallest counterclockwise or clockwise rotation angle from a direction of said user among information sources existing within a prescribed range from the location of said user in the virtual space; and
said moving means moves the user close up to the information source identified by said identifying means.

13. An information source selection system according to claim 11, wherein:
said information source selection system further comprises an identifying means that identifies an information source as a moving destination, based on the movement instruction received by said movement receiving means;
in the case where said movement instruction is judged to mean a forward or backward movement;
when the front-back direction length of the line segment as the movement instruction is larger than a prescribed length, then said identifying means identifies an information source that exists closest from the location of the user in the virtual space, among users existing in front or rear of the user; and
said moving means moves the user close up to the information source identified by said identifying means.

14. A client terminal that selects an arbitrary information sources out of a plurality of information sources, using a virtual space, wherein:
said virtual space includes said plurality of information sources; and
said client terminal comprises:
a movement instruction input means that is used for inputting a movement instruction on a movement of a user of the client terminal in the virtual space;
a moving means that moves the user in the virtual space, according to the movement instruction inputted by said movement instruction input means;
a sending means that sends a first positional information on a location of the user moved by said moving means in the virtual space;
a receiving means that receives a second positional information on a location of each of said plurality of information sources in the virtual space;
a space modeling means that calculates the location of said user and the locations of said plurality of information sources in the virtual space, based on said first positional information on the location of said user in the virtual space and said second positional information on the location of each of said plurality of information sources in the virtual space; and
a sound control means that controls sound effects applied to a voice of each of said plurality of information sources, based on the locations calculated by said space modeling means.

15. A client terminal according to claim 14, wherein:
said first positional information and said second positional information include locations and directions in the virtual space;
said plurality of information sources are streaming voice sources or voices of other users; and
said sound control means controls sound effects, which are applied to voice of each of said plurality of information sources, using a three-dimensional sound technique, and based on a distance and direction between said user and each of said plurality of information sources, with said distance and direction being calculated by said space modeling means.

16. A client terminal according to claim 14, wherein:
said first positional information and said second positional information include locations and directions in the virtual space;
said client terminal further comprises an image generation means that generates image data to output to a display screen, using a three-dimensional graphics technique, and based on a distance and direction between said user and each of said plurality of information sources, said distance and direction being calculated by said space modeling means; and
said image generation means generates the image data to output to the display screen, always fixing the location and direction of said user in the virtual space.

17. An information source selection method for selecting an arbitrary information source out of a plurality of information sources, using a virtual space, wherein:
said virtual space includes said plurality of information sources; and
a client terminal performs following steps, namely:
a movement receiving step in which a movement instruction on a movement of a user) in the virtual space is received;
a moving step in which the user is moved in the virtual space, according to the movement instruction received in said movement receiving step;
a sending step in which positional information on a location of the user moved in the virtual space in said moving step to a server apparatus that manages locations of said plurality of information sources in the virtual space;
a receiving step in which positional information on the location of each of said plurality of information sources in the virtual space from said server apparatus;
a calculation step in which the location of said user and the locations of said plurality of information sources in the virtual space are calculated based on said positional information on the location of said user in the virtual space and said positional information on the location of each of said plurality of information sources in the virtual space; and
a sound control step in which sound effects applied to a voice of each of said plurality of information sources is controlled based on the locations calculated in said calculation step.

18. An information source selection method according to claim 17, wherein:
voice data and/or moving picture data distributed by a streaming server that distributes voice data/or moving picture data are among said plurality of information sources.

19. An information source selection method according to claim 18, wherein:
a storing means of said server apparatus stores virtual space properties that includes places at which said voice data and/or moving picture data among said plurality of information sources are arranged in the virtual space; and
said client terminal further performs an information source receiving step in which positional information on a location of each of said plurality of information sources including said voice data and/or moving picture data is received from said server; and
in said calculation step, a location of each of the voice data and/or moving picture data among said plurality of information sources in the virtual space is calculated based on the location of each of said plurality of information sources including said voice data and/or moving picture data in the virtual space; and
in said sound control step, sound effects applied to a voice of each of the voice data and/or moving picture data among said plurality of information sources are controlled based on the locations calculated in said calculation step.
